(19) United States
(12) Patent Application Publication
(10) Pub. No.: US 2016/0040456 A1
(43) Pub. Date: Feb. 11, 2016

(54) Assemblies for Personal Restraint

(71) Applicant: Restraints Solutions, Inc., Atlanta, GA (US)

(72) Inventor: James C. Smith, Atlanta, GA (US)

(21) Appl. No.: 14/822,428

(22) Filed: Aug. 10, 2015

Related U.S. Application Data
(63) Continuation of application No. PCT/US2014/015636, filed on Feb. 10, 2014.
(60) Provisional application No. 61/762,958, filed on Feb. 10, 2013.

(51) Int. Cl. E05B 75/00; A41D 19/015; E05B 63/00; A41D 19/01

(52) U.S. Cl. CPC E05B 75/00; A41D 19/01; A41D 19/01582; E05B 63/00

(57) ABSTRACT

The present invention discloses enclosure assemblies for the restraint of humans, primates and other animals, such as for restraint of a person's hands. The enclosure assemblies can be combined to provide systems and kits for restraint. Methods of making and using the disclosed assemblies, systems and kits are disclosed herein.

### RELATED APPLICATIONS

This application claims the benefit of priority of U.S. Provisional Patent Application No. 61/762,958, filed Feb. 10, 2013, which is incorporated herein in its entirety.

### TECHNICAL FIELD

The various embodiments of the present invention relate generally to assemblies such as hand restraint enclosure assemblies, belt restraints and other assemblies for restraining the hands and arms of persons under control by others, and methods for their use.

### BACKGROUND OF THE INVENTION

When prisoners or inmates of city, county, state or federal prisons are removed from the controlled environment where they generally reside, the risk of harm to themselves and to others, and the risk of escape, increases. Additionally, people who are uncontrollable such as those intoxicated by drugs or alcohol, or who need to be contained for treatment due to the risk of harming themselves or others, can need restraint assemblies. When military or police officers restrain persons in the field, far from a secure location, securing the restrained persons, and controlling the entire hands of the restrained persons could be important in retaining evidence, prevention of loss of contraband, and safety of the officers. Currently, approaches used in transporting inmates, military prisoners or transport by police officers of suspected persons detained, involve some sort of shackles on the arms, legs, waist or neck of the person being transported. Handcuffs, whether attached moveably by a chain or a rigid member, and belly chain shackles are well known. These restraints do not encase the entire hand, and thus evidence on the hands can lost, the fingers of the restrained person are still functionable and can access items in escape attempts, in attempts to harm others or self, and the person can dispose of assemblies on his or her body.

Persons who are restrained, such as inmates from prisons, are often transported from the controlled environment of the prison to a court, or a medical facility, for example. Such transport is a risk point for escape or obtaining contraband, or self harm, or harm to others and restraints are often used. What is needed are restraint assemblies that can provide visual assurance to the guard in charge of the restrained hands, and that isolates the hands of a restrained person to prevent removal of contamination, or disposal of contraband items or the procurement of a weapon by the restrained person. It is also beneficial if the restraints are easily and quickly manipulated without requiring many separate pieces.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, the present invention comprises a hand restraint enclosure assembly. The hand restraint enclosure assembly further comprises an enclosure having a closed end and an open end opposite the closed end formed by joining a front panel and a back panel. The enclosure is operable to receive at least one hand with an applied cuff. The front panel and the back panel can cooperate to form a cuff region proximate the open end, where the front panel comprises a front portion of the cuff region and the back panel comprises a back portion of the cuff region. The enclosure can further comprise a handcuff aperture defined in the back portion of the cuff region configured to provide access to the applied cuff when the cuff is positioned in an interior of the enclosure. The enclosure can further comprise a handcuff clip operatively associated with the cuff region, where the handcuff clip is operable to secure the enclosure to the applied cuff. The enclosure can further comprise a constraining strap operatively associated with the cuff region that can be configured to minimize the relative movement between the hand and the enclosure.

In other aspects, the hand restraint enclosure assembly can further comprise a dual hand restraint enclosure assembly. In this aspect, the front panel and the back panel can cooperate to define a cuff region extending along an axis passing through the center of the closed end and a center of the open end, where the front panel comprises a front portion of the cuff region and the back panel comprises a back portion of the cuff region.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### DESCRIPTION OF THE FIGURES

FIG. 1 shows a front perspective view of one embodiment of a dual hand enclosure assembly, showing two individual enclosure assemblies, each having a transparent front material, a mesh back material, and a cuff region comprising a plurality of constraining apertures which form openings opposed to each other in both the front and back material of the enclosure assembly in the cuff region, through which the constraining strap can interweave. The cuff region can comprise a reinforcing material affixed to the outer surfaces of each of the front and back panel of the enclosure assembly. The exemplary dual hand enclosure assembly can have one constraining strap having one end affixed to one of the individual enclosure assemblies in the cuff region and the free end of the constraining strap can be interwoven through the constraining apertures of both enclosure assemblies to cinch each enclosure assembly closed and to restrain the two enclosure assemblies in a location in close proximity to each other. The individual enclosure assemblies can be attached to each other through a connection member, located about midway between the open top ends and closed bottom ends of the two enclosure assemblies, and attached therebetween the two enclosure assemblies. The connection member can comprise a handcuff attachment clip as shown.

FIG. 2 shows a view of the dual hand enclosure assembly with each of the enclosure assemblies angled away from the connection member. Two constraining apertures are visible in the cuff region of the enclosure assembly on the left of FIG. 2. The flexibility provided by a dual hand enclosure assembly and the connection member is shown and FIG. 2 illustrates the transparent material forming the front of each enclosure assembly, and a connection member having a handcuff attachment clip, a short handcuff strap and an attachment ring.

FIG. 3 is a back view of the dual hand enclosure assembly of FIG. 1, with the view showing the back material of dual hand enclosure assembly. The back material can be a mesh material. Each enclosure assembly can have a cuff region of the back material comprising a reinforced material attached to the back material and through which an aperture shown in the back material provides an opening from the outside of the enclosure assembly through the reinforced material attached to the back material, through the back material to the interior of the enclosure assembly. An aperture in the front material can be located immediately opposite the aperture in the back material so that the aperture in the front material provides an opening from the interior of the enclosure assembly, through any affixed reinforced material that can be present, to the exterior of the enclosure assembly on the front side of the enclosure assembly.

FIG. 4 shows a dual hand enclosure assembly with a pair of handcuffs restrained by the handcuff attachment clip on the free end of a handcuff strap having the opposite end of the handcuff strap affixed to the connection member. An attachment ring is shown below the handcuff attachment clip.

FIG. 5 shows the placement of a hand within one hand restraint enclosure assembly of the dual hand enclosure assembly wherein the hand can be maintained in a handcuff and the hand can be visible from the front side of the dual hand enclosure assembly due to the transparent material of the front side.

FIG. 6 shows the dual hand enclosure assembly attached to a waist restraint belt.

FIG. 7 is a close up picture of the connection member of a dual hand enclosure assembly, wherein the handcuff attachment clip can be engaged with the chain of a pair of hand cuffs and the attachment ring on the connection member can be engaged with an attachment strap of a waist restraint belt, as the combined assembly of dual hand enclosure assembly and waist restraint belt shown in FIG. 6.

FIG. 8 shows a view from the open end (top) of the enclosure assemblies of the dual hand enclosure assembly, illustrating the constraining strap connecting the two enclosure assemblies, in addition to the connection provided by the connection member, not shown in this figure.

FIG. 9 shows the cuff region at the open end of a dual hand enclosure assembly illustrating the attachment rings where an attachment clip can be engaged with either one the plurality of rings present to provide for variable restriction of the opening of the enclosure assembly. The reinforcement material of the cuff can be seen.

FIG. 10 shows an attachment clip engaged with an attachment ring found on a waist restraint belt, for attaching one end of the belt to the belt. The attachment of one end of the belt to a location on the belt by the attachment clip engaged with the attachment ring can be strengthened by the presence of hook and loop material, such as Velcro, with one half of the material present on the belt and the other half of the material present on the side opposite the affixed attachment clip.

FIG. 11 shows an exemplary dual hand restraint enclosure assembly.

FIG. 12 shows a dual hand restraint enclosure assembly with the constraining strap moved to show the constraining aperture and handcuff aperture, and the handcuff strap comprising a handcuff attachment clip.

FIG. 13 shows a pair of handcuffs stabilized within the dual hand restraint enclosure assembly by the handcuff strap entering the interior of the enclosure assembly through the handcuff aperture and engaging the handcuffs with the handcuff attachment clip.

FIG. 14 shows an exemplary dual hand restraint enclosure assembly having handcuffs maintained in substantially one place by the handcuff strap entering the interior of the enclosure assembly through the handcuff aperture and engaging the handcuffs with the handcuff attachment clip and the free end of the constraining strap passing through the constraining aperture from the front of the enclosure assembly to the back of the enclosure assembly, returning to the front by passing over the open end of the enclosure assembly and engaging the attachment clip of the constraining strap with the attachment ring affixed to the reinforced material affixed to the enclosure assembly.

FIG. 15 shows a close up view of the constraining strap attachment clip engaged with an adjustment ring on the front material of a dual hand restraint enclosure assembly.

FIG. 16 shows the reverse side, the back of the enclosure assembly of the dual hand restraint enclosure assembly shown in FIG. 15.

FIG. 17 shows an embodiment of the present invention comprising two single enclosure assemblies, each comprising strap wherein the free end comprises a handcuff, and each hand restraint enclosure assembly can be attached to a waist restraint belt. An enclosure assembly having an affixed strap comprising a single handcuff can be referred to herein as a hand restraint enclosure assembly comprising a handcuff

FIG. 18 shows a closure mechanism of a waist restraint belt comprising an attachment clip and an attachment ring. A sleeve to cover the attachment clip can be provided.

FIG. 19 shows the back of a hand restraint enclosure assembly comprising a handcuff wherein a handcuff attachment clip can be engaged with the ring that affixes the handcuff to the strap comprising a handcuff on its free end.

FIG. 20 shows the free end of the strap comprising a handcuff, of a hand restraint enclosure assembly comprising a handcuff, wherein the strap can be removed from the interior of the hand restraint enclosure assembly and the individual cuff is shown outside of the hand restraint enclosure assembly.

FIG. 21 shows the free end of a constraining strap of a hand restraint enclosure assembly comprising a handcuff engaged with an attachment ring located in the cuff region of the hand restraint enclosure assembly.

FIG. 22 shows the back of a hand restraint enclosure assembly comprising a handcuff where the handcuff strap comprising a handcuff attachment clip is not engaged and also shows apertures in the cuff region of the hand restraint enclosure assembly. FIG. 22 also shows the constraining strap interwoven through the constraining apertures.

FIG. 23 shows the back (mesh) side of the cuff region illustrating the handcuff strap and handcuff attachment clip, wherein the handcuff attachment clip can be engaged with the chain of a handcuff.

FIG. 24 shows the back (mesh) side of the cuff region illustrating the handcuff strap and handcuff attachment clip, wherein the handcuff attachment clip can be engaged with the chain of a handcuff.

FIG. 25 shows the handcuff strap and handcuff attachment clip adjacent to the handcuff aperture through which the handcuff can be engaged by the handcuff attachment clip. Additionally, the constraining strap is shown interwoven through the constraining apertures of the hand restraint enclosure assembly.

FIG. 26 shows the constraining strap of the hand restraint enclosure assembly with its attachment clip engaged with an attachment ring affixed to the cuff region of the hand restraint enclosure assembly.

FIG. 27 shows the front (transparent) side of an exemplary hand restraint enclosure assembly wherein a constraining strap can be woven through the constraining apertures.

FIG. 28 shows a restraint vest from a bottom perspective looking towards the neck region of the vest. Two separate attachment rings are shown on the left and on the right for the belt loop closure system is shown. The vest can be made from a unitary piece that forms the front and back sections. Reinforcing material can be present where needed.

FIG. 29 shows a close up of the vest attachment rings showing an attachment system on the left-hand side and its paired attachment ring on the right such that when the clip can be engaged with the attachment ring a belt loop can be formed such that a waist restraint belt could be held in connection with the restraint vest.

FIG. 30 shows the extended belt loop in an open position indicating a row of hook and loop material which functions to close the belt loop in addition to the paired clip and attachment ring to form a belt loop which can contain a waste restraint belt.

FIG. 31 shows both open belt loop members of a vest.

FIG. 32 shows a close up of the belt loop attachment ring and paired clip.

FIG. 33 shows the belt loop in a closed position with the hook and loop material engaged and not shown can be the paired clip and attachment ring.

FIG. 34 shows side closure and adjustment member of a vest.

FIG. 35 shows a close up of the side closure and adjustment member.

FIG. 36 shows both side closure and adjustment member comprising three rings and also the belt loop member for a belt loop.

FIG. 37 shows a closed side closure and adjustment member.

FIG. 38 shows a restraint vest.

FIG. 39 shows a restraint vest in combination with two single hand restraint enclosure assemblies comprising a handcuff.

FIG. 40 shows a restraint vest in combination with two single hand restraint enclosure assemblies comprising a handcuff.

FIG. 41 shows an enclosure assembly having a constraining strap and constraining apertures that provide wrist/arm separation and thus hand separation.

FIG. 42 shows the enclosure assembly of FIG. 41 and a pair of flex cuffs is shown within the enclosure assembly.

FIG. 43 shows the enclosure assembly containing flex cuffs.

FIG. 44 shows the back of the enclosure assembly of FIG. 41.

FIG. 45 shows the interior of the enclosure assembly and the hand separation provided by the constraining strap.

FIG. 46 shows an enclosure assembly with a central aperture there through.

FIG. 47 shows an enclosure assembly with a central aperture enclosing a set of flex cuffs and attached to a waist restraint belt.

FIG. 48 shows an enclosure assembly with a central aperture encasing flex cuffs and attached to a waist restraint belt, wherein a zip tie can be used to constrain the enclosure assembly.

FIG. 49 shows the enclosure assembly and the zip tie closure, and the enclosure assembly can be attached to a waist restraint belt.

### DETAILED DESCRIPTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein, while still obtaining the beneficial results described herein. It will also be apparent that some of the desired benefits described herein can be obtained by selecting some of the features described herein without utilizing other features. Accordingly, those who work in the art will recognize that many modifications and adaptations to the present invention are possible and can even be desirable in certain circumstances and are a part described herein. Thus, the following description is provided as illustrative of the principles described herein and not in limitation thereof.

Reference will be made to the drawings to describe various aspects of one or more implementations of the invention. It is to be understood that the drawings are diagrammatic and schematic representations of one or more implementations, and are not limiting of the present disclosure. Moreover, while various drawings are provided at a scale that is considered functional for one or more implementations, the drawings are not necessarily drawn to scale for all contemplated implementations. The drawings thus represent an exemplary scale, but no inference should be drawn from the drawings as to any required scale.

In the following description, numerous specific details are set forth in order to provide a thorough understanding described herein. It will be obvious, however, to one skilled in the art that the present disclosure may be practiced without these specific details. In other instances, well-known aspects of personal restraint have not been described in particular detail in order to avoid unnecessarily obscuring aspects of the disclosed implementations.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

As used in the specification, directional and/or relationary terms such, but not limited to, “left”, “right”, “top”, “bottom”, “front”, “back”, “horizontal” and “lateral” are relative to each other and are dependent on the specific orientation of an applicable element or assembly and are used accordingly to aid in the description of the various embodiments and are not necessarily intended to be construed as limiting.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be predefined it is understood that each of these additional steps can be predefined with any specific aspect or combination of aspects of the disclosed methods.

The present invention comprises systems, methods and assemblies for confining subjects, for example humans. The present invention comprises restraint assemblies, particularly restraint assemblies wherein one or both hands of a restrained person can be contained within an enclosure assembly. The present invention comprises systems of restraint assemblies for restraining persons. The present invention comprises methods of use of the restraint assemblies and methods of making such assemblies. The present invention can be useful for confining the hands of restrained persons, while providing visual confirmation that the hands can be restrained by handcuffs or similar restraints and can be fully within the enclosure assembly for the person in control. The present invention provides care for the restrained person in that the enclosure assembly or assembly can be made from a breathable, though strong, mesh to allow some air circulation to the hands. Additionally, the closure of an enclosure assembly does not restrict the flow of blood to the hands, as handcuffs or zip tie restraints do when adjusted and closed too tightly on the restrained person. Isolation of the hands can be beneficial in instances such as when the restrained person can have contraband on his/her body and/or can have identifying materials on his/her hands. Additionally, the restrained person can be transported more safely when his/her hands are enclosed within the assemblies disclosed herein, or in a system or kit provided herein.

An enclosure assembly of the present invention can comprise two pieces of material of the same shape that can be substantially affixed to each other so that approximately two-thirds of the edges can be affixed to each other and approximately one-third of the two edges can be left free. The two-thirds affixed region of the two pieces of material form an enclosure assembly and the unfixed edges form the opening of the enclosure assembly. As referred to herein, one piece of material can be referred to as the front of the enclosure assembly and the other material can be referred to as the back of the enclosure assembly. As referred to herein, the closed region of the enclosure assembly opposite the opened region can be referred to as the bottom of the enclosure assembly and the open region can be referred to as the top of the enclosure assembly, for orientation and understanding of relative parts of the assembly. In an aspect, a gusset of material, such as mesh material, can be affixed between the usually affixed regions of the enclosure assembly, generally in the bottom area of the enclosure assembly, and allow the front and back pieces to be removed from each other to provide an enclosure assembly where the lower portion of the enclosure can have more three dimensional depth than with an enclosure assembly where the front and back materials can be affixed directly to each other. Larger hands can need an enclosure assembly with a gusset.

In an aspect, the front of an enclosure assembly can be made from a transparent or clear material so that the interior of the enclosure assembly can be visible from the outside of the enclosure assembly. In an aspect, both the front and enclosure assembly material can be made from a transparent material. In an aspect, the front of the enclosure assembly can be made from a transparent or clear material and the back of the enclosure assembly can be made from a sturdy material, woven or nonwoven, which can be tear resistant. For example, the back of the enclosure assembly can be made of a sturdy mesh material. In an aspect, an enclosure assembly comprises a front material that can be transparent or clear. In an aspect, an enclosure assembly comprises a back material that allows for transmission of air into and out of the interior of the enclosure assembly, such as a tear resistant mesh.

An enclosure assembly of the present invention can have one or more areas of the enclosure assembly having a reinforced material, attached to the front or back material of the enclosure assembly, and such a reinforced material generally found on the exterior surface of a front material and/or on the exterior surface of the back material. The reinforced material can be planar and can have two surfaces. One surface of the reinforced material can be attached to the exterior surface of the material of an enclosure assembly, front and/or back material, and the opposing surface forms an exterior surface of the enclosure assembly to which other elements of the enclosure assembly can be affixed. For example, a cuff region can comprise an area of reinforced material. An aperture can be made through an area of reinforced material. An attachment clip or a handcuff attachment clip can be attached to an enclosure assembly at an area of reinforced material. An attachment site or one or more attachment rings can be attached to an enclosure assembly at an area of reinforced material. A strap, such as a constraining strap, or an attaching strap or a handcuff strap, can be attached to an enclosure assembly at an area of reinforced material. Reinforced material can be made of webbing or a sturdy woven or nonwoven material that resists tearing, such as ballistic nylon, or other similar fabrics known to those of skill in the art. Herein where apertures can be disclosed as providing an opening through one or both materials of an enclosure assembly, it can be intended that a reinforced material can be present and the aperture can be also through the reinforced material. Herein, where it can be disclosed that a strap or attachment site or attachment rings or an attachment clip can be attached to the front and/or back of an enclosure assembly, it can be intended that a reinforced material can be present and that a strap or attachment site or attachment rings or an attachment clip can be affixed to a reinforced material that can be affixed to the exterior surface of a front or back material of an enclosure assembly. For simplicity, the reinforced material is not disclosed in every following description when apertures or attaching members are discussed, but one of skill in the art would understand that the reinforced material can be present even if not specifically noted. Further, the presence of reinforced material may not be required, and even where reinforced material is disclosed the invention should not be seen to be limited by its required presence, and one of skill in the art can determine if the material of which the enclosure assembly can be made would require the presence of the reinforcing material at the sites where a strap or attachment site or attachment rings or an attachment clip, or a cuff, or other aspects of the enclosure assembly can be attached to the front and/or back material of the enclosure assembly and would require such reinforcing material.

An enclosure assembly of the present invention can comprise a cuff region found at the open end of the enclosure assembly. A cuff region can be an area of attached reinforced material, such as webbing, that can be attached to the front material and/or to the back material on the outer surfaces of the front and back material, but does not close the enclosure assembly and the open end of the enclosure assembly remains open. A cuff region can comprise a constraining strap, a one piece belt or strap, generally made from a strong webbing material, having opposing ends, wherein one end can be affixed to the cuff region and the other end can be free to move. The free end of the constraining strap can have an attachment clip, for example a clip, a carabineer, a latch or other attachment means known in the art for securing the free end of a strap to one location, wherein the attachment clip forms a closed ring having a portion of the attachment clip that can be movable to open and close the ring. When closed, the attachment clip will not engage and interact with attachment sites, such as attachment rings. When the movable portion can be moved to open the ring, the attachment clip can interact with an attachment site and surround a portion of that site, to secure the attachment clip to the attachment site when the movable portion can be moved to form the closed ring again. A spring mechanisms can be useful in movement of the movable portion. Such attachment clips can be well known in the art and known and future developed attachment clips can be contemplated by the present invention. Other engaging closure mechanisms can be used in place of such clips. For example, mating closures found in seat belts, where one end, sometime referred to as a female end, engages a locking end, sometimes referred to as a male end, can be used in the present invention. In an aspect, an enclosure assembly of the present invention can comprise one or more constraining straps. In an aspect an enclosure assembly or assembly comprising two enclosure assemblies of the present invention can comprise only one constraining strap.

A cuff region can comprise one or more constraining apertures therethrough the front and back material of an enclosure assembly. Constraining apertures can be used by a constraining strap. The free end of a constraining strap can be interwoven through the apertures so that when the free end of the constraining strap can be engaged with an attachment site, the top edges of the enclosure assembly can be brought closer together to cinch the enclosure assembly closed around the wrist of the restrained hand. The combination of cuff apertures and the interwoven constraining strap allows for the top of the enclosure assembly to be adjustably closed. A closed enclosure assembly can be quickly opened by releasing the attachment clip from the attachment site, thus releasing the free end of the constraining strap, allowing the strap to be removed from the apertures and allowing for moving the open end edges of the enclosure assembly apart from each other.

An enclosure assembly of the present invention can comprise a handcuff strap having a handcuff attachment clip. An enclosure assembly comprises a handcuff aperture, generally an aperture in the body of the enclosure assembly that can be an aperture in only one piece of material and not through the facing second piece of material. For example, a handcuff aperture can be found only in the mesh material and not in the transparent material. In a location on one piece of material, such as the back piece, one end of a handcuff strap can be firmly attached to the material. The free end of the handcuff strap can have a handcuff attachment clip, which can be a clip or other engaging locking mechanism as disclosed herein and as can be known in the art. In use, the free end of the handcuff strap can be moved from the exterior of the enclosure assembly to the interior of the enclosure assembly, where a hand would be present. The handcuff attachment clip can be engaged with a portion of the handcuff, such as a chain between the two cuffs, to restrain the movement of the handcuffs within the enclosure assembly.

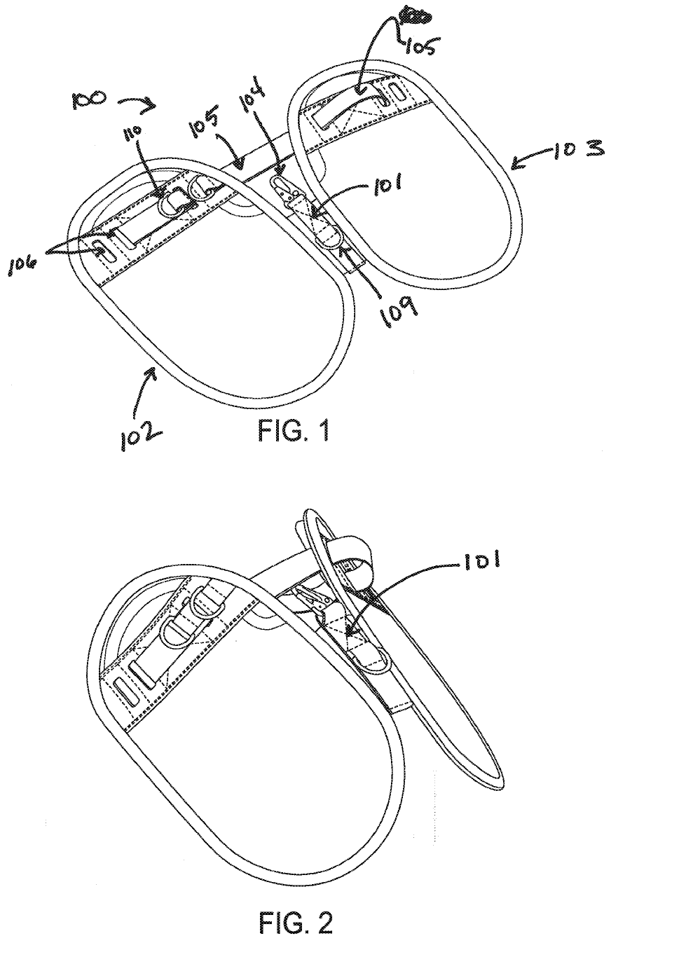

In an aspect, enclosure assembly of the present invention can comprise a handcuff strap having a handcuff attachment clip located on a connection member. In an aspect, an enclosure assembly cannot comprise a handcuff aperture. In an aspect, for example as shown in FIGS. 1-9 for a dual hand enclosure assembly, one end of a handcuff strap can be firmly attached to the material of the connection member. The free end of the handcuff strap can have a handcuff attachment clip, which can be a clip or other engaging locking mechanism as disclosed herein and as can be known in the art. The handcuff attachment clip can engage with a portion of a pair of handcuffs, such as the chain or rod found between the individual cuffs of the pair of hand cuffs and linking the two cuffs.

Reference will now be made to the drawings to describe various aspects of one or more implementations of the invention. It is to be understood that the drawings are diagrammatic and schematic representations of one or more implementations, and are not limiting of the present disclosure. Moreover, while various drawings are provided at a scale that is considered functional for one or more implementations, the drawings are not necessarily drawn to scale for all contemplated implementations. The drawings thus represent an exemplary scale, but no inference should be drawn from the drawings as to any required scale.

In the following description, numerous specific details are set forth in order to provide a thorough understanding described herein. It will be obvious, however, to one skilled in the art that the present disclosure may be practiced without these specific details. In other instances, well-known aspects of personal restraint have not been described in particular detail in order to avoid unnecessarily obscuring aspects of the disclosed implementations.

An exemplary assembly of the present invention comprises a dual hand enclosure assembly, as illustrated in FIGS. 1 through 9. As shown in FIG. 1, a dual hand the first enclosure assembly 100 comprises two individual enclosure assemblies 102, 103 adjoined in a central location by a connection member. As shown in FIG. 1, and disclosed more fully herein, the enclosure assemblies of the dual hand enclosure assembly can be substantially mirror images of each other. The enclosure assembly on the left can have two constraining apertures in close proximity to each other and to the left most outer edge of the left enclosure assembly, and an individual aperture closer to the right most edge of the left enclosure assembly, whereas the enclosure assembly on the right can have the individual aperture closest to the left most edge of the right enclosure assembly and the two apertures in close proximity to each other can be in close proximity to the right most edge of the right enclosure assembly. As disclosed herein, the enclosure assembly on the left provides the affixed end of the constraining strap 105 and the attachment site 110 (attachment rings) for engagement with the free end of the constraining strap comprising an attachment clip 107. The enclosure assembly on the right does not have a constraining strap and does not have an attachment site.

As shown in FIG. 1, in a dual hand enclosure assembly 100, the individual enclosure assemblies 102, 103 can be adjoined by a connection member 101, in a side-to-side or laterally in the same plane. In making a dual hand enclosure assembly, the enclosure assembly comprising a constraining strap can be connected on the left of the second enclosure assembly so that the free end of the constraining strap of the first enclosure assembly can be weaved from the front of the enclosure assembly to the back of the enclosure assembly through a cuff region aperture proximate to and to the right of the affixed end of the constraining strap and then weaved from the back of the second enclosure assembly to the front of the second enclosure assembly through a right-most cuff region aperture on the second enclosure assembly. The connection member can be affixed to each of two of the individual enclosure assemblies and can be located between them so as to connect them in a side to side relationship, laterally, with both open ends in the same orientation and likewise, the same orientation for the closed bottom ends. The connection member can be made of a tough tear-resistant material, such as ballistic nylon, Cordura®, or other strong material, such as webbing made from nylon or other tear resistant materials known to those of skill in the art. The connection member can comprise an attachment clip for engaging with an attachment strap of another assembly or a structure, or for maintaining the dual enclosure assembly hand restraint in a particular location.

As shown in FIG. 1, the shape of the enclosure assembly 102, 103 can be an oval, though the invention is not limited to the shapes shown herein and other shapes can be contemplated. An oval shape can be provides some advantage in that it lacks squared points or corners where the edges come together, such as can be found in square or rectangular objects. Such corners can be eroded more easily with wear and tear of use, or can be used as a weapon by the wearer. In an aspect, an enclosure assembly can be square, rectangular, polygonal, or any shape to form an enclosure assembly that encases the entire hand. Other shapes can be contemplated.

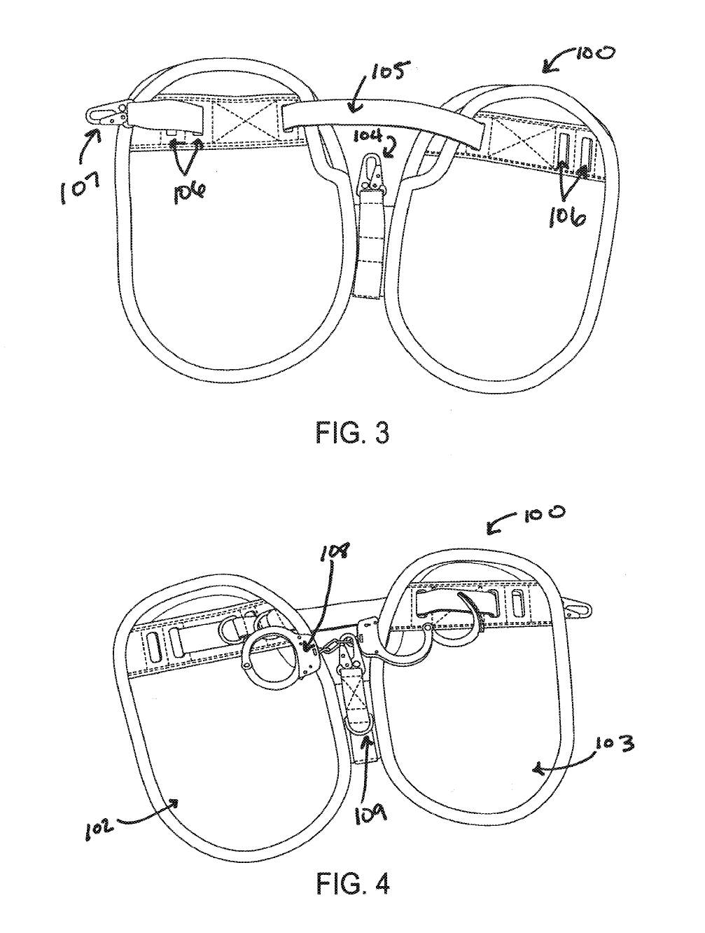

As shown in FIG. 1 through 9, the exemplary dual hand enclosure assembly 100 comprises two enclosure assemblies 102, 103 each made of two pieces of material, one of which can be a clear or transparent material such as vinyl or heavy strength vinyl, forming the front surface of the enclosure assembly, and the other material, forming the back surface of the enclosure assembly can be a mesh material which allows for movement of air to the confined hands. FIG. 2 shows the dual hand enclosure assembly 100 moved to form an angle showing the connection member between and connecting the two individual enclosure assemblies 102, 103. A close up of the back of the assembly is shown in FIG. 3, from the back material (mesh) side of the dual hand enclosure assembly. Looking at FIG. 3, the handcuff latch 104 can be clearly seen attached to the connecting member. The strap portion 105 found at the open end of the dual enclosure assembly shows a strap interwoven through the apertures 106 and connecting the two enclosure assemblies together.

In use, handcuffed hands can be placed within the enclosure of the hand restraint enclosure assembly, between the front and back materials. In a dual hand enclosure assembly 100 comprising two enclosure assemblies 102, 103, one hand can be placed in one enclosure assembly and the other hand can be placed in the other enclosure assembly, so that each enclosure assembly encloses one hand. The placement of each of the hands can be visible through a transparent front material. The dual enclosure assembly hand restraint comprises a handcuff strap, having an affixed end affixed to the connection member material, and having a free end comprising a handcuff attachment clip. The handcuff attachment clip engages a portion of the handcuffs to reduce the movement of the handcuffed hands within the enclosure assembly. For example, each of the individual cuffs of a pair of handcuffs can be connected to the other by a chain or a rod, and the handcuff attachment clip engages a link in the chain or an opening in the rod that connects the cuffs. In looking at the dual hand enclosure assembly exemplified in FIG. 1-9, in FIG. 1, the affixed end of the constraining strap 105 can be affixed to the enclosure assembly on the left, on the front of the right hand side of the first enclosure assembly, closest to the other enclosure assembly. The location and placement of the constraining apertures 106 of the first enclosure assembly 102 can be a mirror image of the location and placement of the constraining apertures 106 of the second enclosure assembly 103. The free end of the constraining strap 105, comprising an attachment clip 107, can be used to weave in and out of the constraining apertures to substantially close each enclosure assembly and to connect the tops of the enclosure assemblies to each other. For example, the free end of the constraining strap, affixed to the front of the first enclosure assembly 102 in the cuff region, can be moved through the first cuff region aperture on the first enclosure assembly, which can be the cuff region aperture closest to the connection member, in a direction from the front to the back of the first enclosure assembly. In this embodiment, the first aperture of the first enclosure assembly 102 can be located between two attachment rings located in the cuff region which can be the attachment sites for the attachment clip of the constraining strap of the dual hand enclosure assembly. The free end can be then moved through cuff region aperture 1 of the second enclosure assembly 103 in a direction from the back of the second enclosure assembly through the aperture to the front of the second enclosure assembly. A this point, the next aperture through which the constraining strap can be go can be depend on the size of the constrained hands, or the extent of constriction of the hands and two enclosure assemblies desired. The free end of the constraining strap can be then moved from the front to the back of the second enclosure assembly, through the second cuff region aperture of the second enclosure assembly (located between the first and third constraining apertures) or through the third cuff region aperture of the second enclosure assembly, (the third cuff region aperture can be located closest to the edge of the second enclosure assembly that can be most distant from the connection member). At this point, the second enclosure assembly can be constrained by the constraining strap. With the free end of the constraining strap now in the back of the second enclosure assembly, the free end of the connection strap can be then moved through a cuff region aperture of the first enclosure assembly, from the back side to the front side. A choice of range of constraint can be provided by the choice of use of either the second or third constraining apertures of the first enclosure assembly. The third cuff region aperture, which can be also be referred to as cuff region aperture 3, can be located closest to the edge of the first enclosure assembly that can be most distant from the connection member, and cuff region aperture 2 (the second cuff region aperture) can be between constraining apertures 1 and 3. The choice of aperture 3 creates a larger constrained opening for the enclosure assembly (and around the wrist of a hand so enclosed and restrained), whereas the choice of aperture 2 creates a smaller constrained opening for the enclosure assembly (and around the wrist of a hand so enclosed and restrained). With the movement of the free end of the constraining strap from the back of the first enclosure assembly to the front of the first enclosure assembly through either cuff region aperture 2 or 3, the free end can be on the front side of the first enclosure assembly and the attachment clip on the end of the constraining strap can engage an attachment site on the front of the first enclosure assembly. An attachment site 110 can be one or more firmly affixed rings, which can be referred to as attachment rings. In this embodiment, the attachment site 110 comprises two rings, spaced apart for adjustability, in the cuff region. The constraining strap attachment clip 107 engages one of the rings and completes the restraint of the person whose hands can be enclosed with the two enclosure assemblies. Once the constraining strap 105 has engaged both enclosure assemblies 102, 103, by weaving the constraining strap in and out of the apertures 106, to draw the open ends of the two pieces of material of the enclosure assemblies together, which can be referred to as cinching each enclosure assembly closed, the hands of the person can be restrained. The dual hand enclosure assembly can then be attached to a belt restraint, to another hand restraint enclosure assembly, to a vest, to a belly chain, or any other location as desired and can be accomplished. A hand restraint enclosure assembly can have an attachment strap for attaching the hand restraint enclosure assembly to another assembly or structure, or a hand restraint enclosure assembly can have an attachment site, such as a ring, for engaging with the strap of another assembly or structure, or an attaching element provided by the other assembly or structure.

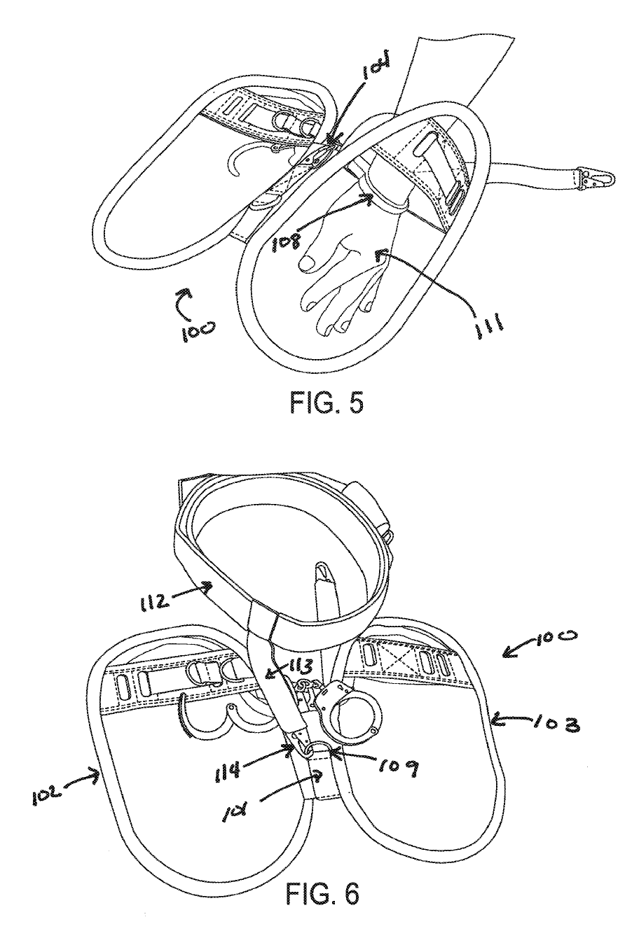

Shown in FIG. 5 is a front view of a dual hand enclosure assembly 100 showing how a restrained hand 111 enclosed within the enclosure assembly can be visible through the clear material of the front of the enclosure assembly, the handcuff attachment clip 104 is shown engaged with the chain of a pair of handcuffs 108, and an attachment ring 109 can be present on the connection member. Such an attachment ring can be used to connect the dual hand enclosure assembly to a restraint belt strap, to a belly chain, or to a structure. As shown in FIG. 6, the dual hand enclosure assembly 100 can be attached to a waist restraining belt 112 through a connecting strap 113 of the waist restraining belt having an attachment clip 114 that can be engaged with the attachment ring 109 of the connection member 101.

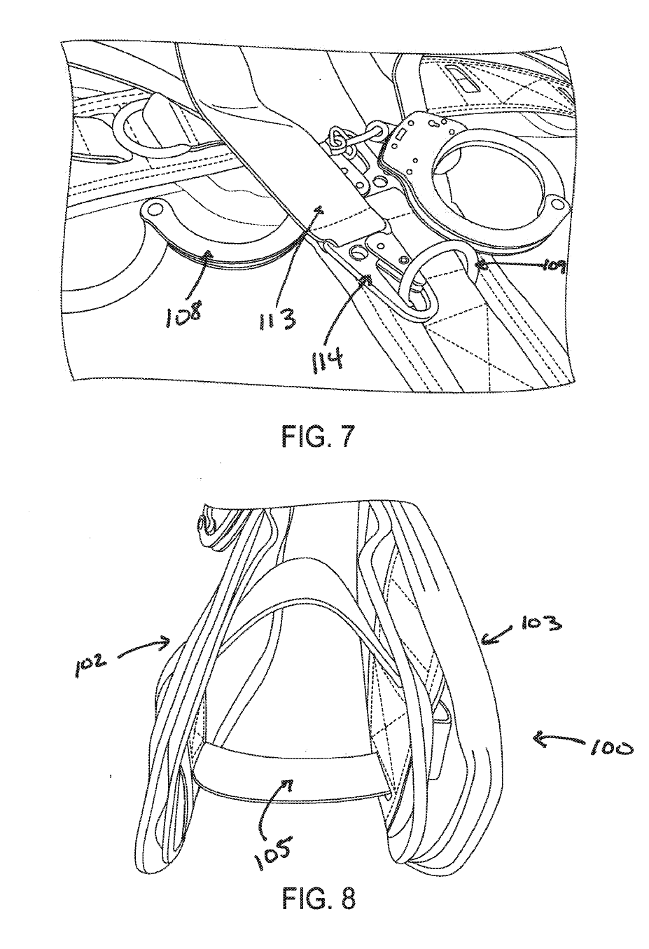

In a method of restraining a person, the hands of the restrained person, previously having handcuffs applied to the wrists, can be placed so that one hand can be in each enclosure assembly and the handcuffs remain in place on the wrists. Once the hands can be in the enclosure assembly, the handcuff attachment clip, affixed to the connection member, can be connected to the chain (or connecting part, which can be a rod) of the handcuffs. Once the handcuffs can be engaged with the handcuff attachment clip, the free end of the constraining strap can be woven through the apertures of each enclosure assembly to constrict the top of each enclosure assembly and to hold the two enclosure assemblies together. A step-by-step disclosure of a method of weaving the free end of the constraining strap can be provided herein. Once the free end of the constraining can be returned to the enclosure assembly having the affixed end of the constraining strap, the constraining strap attachment clip can be engaged with the attachment site present on that enclosure assembly, such as by clipping onto one of a plurality of attachment rings located on the cuff. As shown in FIG. 6, the dual hand enclosure assembly 100 can be attached to a waist restraint belt 112. The waist restraint belt can be attached to an attachment ring 109 found on the connection member 101 of the dual hand enclosure assembly. FIG. 7 shows a close up of the attaching strap 113 and attachment clip 109 of a waist restraint belt 112 engaged with an attachment ring 109 of the connecting member 101 of the dual hand enclosure assembly. The handcuff attachment clip is shown engaged with the chain of the pair of handcuffs.

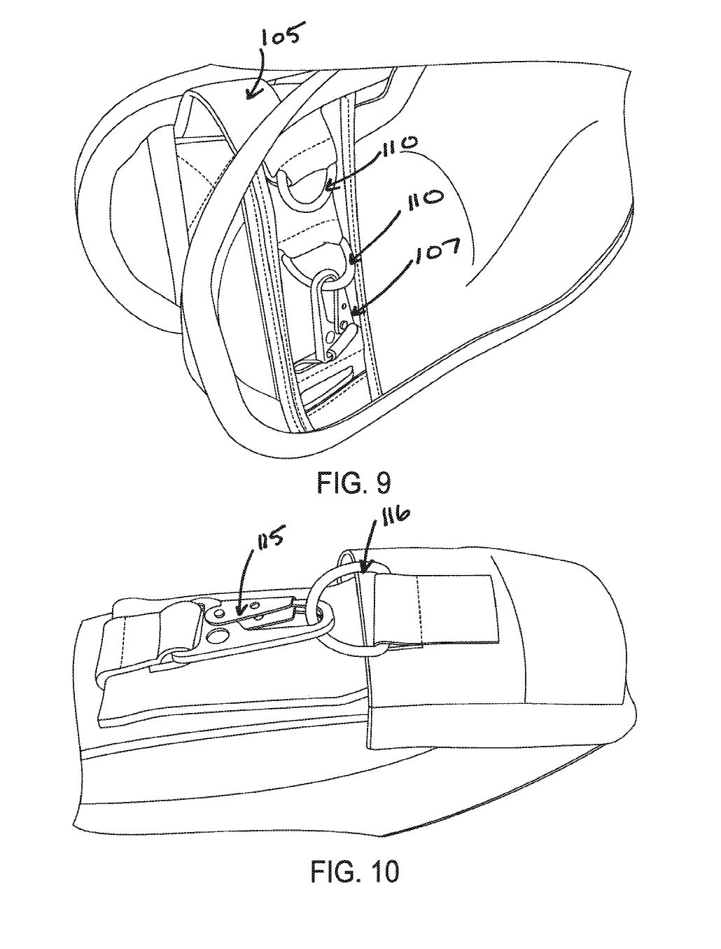

FIG. 8 shows a side view of the open ends of the enclosure assemblies 102, 103 of a dual hand enclosure assembly with the constraining strap 105 interwoven through the apertures 106 of the dual hand restraint assembly for constricting the open portion of the enclosure assemblies and also further connecting the two individual single hand enclosure assemblies together. FIG. 9 shows a close up of the free end of the constraining strap 105 comprising the attachment clip 107 engaged with one of the plurality of attachment rings 110 shown.

In an aspect, the individual enclosure assemblies of the dual hand enclosure assembly shown here are not limited by the number of apertures or the number of straps shown. As needed, apertures can be provided to aid in closure of enclosure assemblies and aid in connection of the enclosure assemblies to each other to belts or to vests as shown. One of skill in the art can determine how many apertures can be needed and how to weave the constraining straps through the apertures to provide a secure environment for the hand. In an aspect, the individual enclosure assemblies of a dual hand enclosure assembly are not a mirror image of each other, and each enclosure assembly can be identical in its placement of apertures and/or straps. Such an identical arrangement would change the pattern of interweaving of the constraining strap or straps. In an aspect, the enclosure assemblies are not be identical in placement of the apertures and/or straps.

FIG. 10 shows the closure mechanism of a waist restraint belt 112. One end of the belt can be held in releasable connection with a section of the belt by engaging an attachment clip 115 on the end of the belt with an attachment ring 116 found on the attachment area of the belt. As is understood, a belt comprises a single strap having two ends. A circular enclosing belt can be formed when a first end is configured to be connected to a portion of the belt generally in proximity to the opposing end. The attachment of the end can be strengthened by the use of a hook and loop material, such as Velcro®. Not shown in this picture, can be a sleeve, made of the belt material, which slides over this belt and engages to cover and to prevent easy access to the attachment clip and attachment ring. The belt can be made of any sturdy material, woven or nonwoven fabric, known to those skilled in the art. For example, the belt can be made from ballistic nylon or Cordura®.

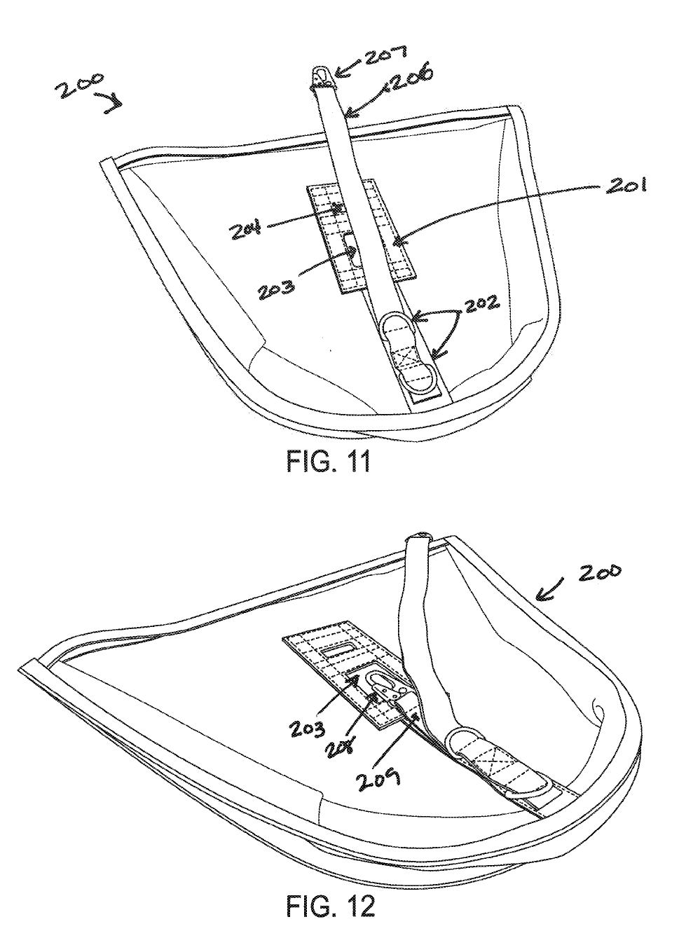

An enclosure assembly of the present invention can be of a size so that both hands of a restrained person can be contained within one enclosure assembly. Such an enclosure assembly can be illustrated in FIG. 11, and can be referred to herein as a dual hand restraint enclosure assembly 200. FIG. 11 shows an enclosure assembly 200 made of two materials that can be placed facing each other to form an enclosure assembly wherein the two materials can be affixed to each other along the edges for approximately two-thirds of the edges of an enclosure assembly. The other unattached edges of the enclosure assembly form the opening and the two materials once affixed through approximately two-thirds of their edges form an enclosure assembly. Like other enclosure assemblies disclosed herein, a dual hand restraint enclosure assembly can be made of two materials, a clear or transparent material used for the front of the enclosure assembly, and the same or a different material used for the back of the back. An enclosure assembly can have a gusset to enlarge the interior enclosure of the enclosure assembly.

As shown in FIG. 11, a dual hand restraint enclosure assembly 200 can have reinforced material 201 affixed to the front material of the enclosure assembly, extending from the bottom seam to approximately midway between the bottom seam and the top, open end, of the enclosure assembly. The reinforced material can have a plurality of attachment rings 202 affixed to the reinforced material. As shown in FIG. 11, two attachment rings 202 can be located on the reinforced material.

The reinforced material can surround and define apertures of an enclosure assembly. The dual hand restraint enclosure assembly 200 of FIG. 11 can have two apertures, a handcuff aperture 203 and a constraining strap aperture 204. The constraining strap aperture can function like a cuff region aperture to provide an aperture defining an opening through both the front and back material, and any reinforced material present, to allow for the passage of the free end of a constraining strap 206 to be moved therethrough from the front to the back of the enclosure assembly, or therethrough from the back to the front of the enclosure assembly.

The reinforced material also provides a site for affixing a constraining strap 206. The constraining strap comprises an affixed end, affixed to the front of the enclosure assembly and a free end comprising an attachment clip 207. Not shown in FIG. 11 can be the handcuff strap, as it can be located on the reinforced material proximate to the affixed end of the constraining strap but the handcuff strap can be affixed at a location closer to the top of the enclosure assembly than the affixed end of the constraining strap, and can be thus under the constraining strap in FIG. 11. The handcuff strap comprises an affixed end that can be affixed to the reinforced material 201 and a free end comprising a handcuff attachment clip 107.

FIG. 12 shows the front of a dual hand restraint enclosure assembly 200 wherein the constraining strap is moved so that the handcuff strap 209 and its handcuff attachment clip 208 are visible. Also shown can be the handcuff aperture 203. The handcuff aperture can be an opening in only the front material, and its associated reinforced material, if present. There can be no corresponding aperture in the back material of the enclosure assembly. The handcuff aperture provides an opening through the front material to access the interior of the enclosure assembly. This access to the interior of the enclosure assembly allows the free end of the handcuff strap to enter the enclosure assembly and if present, the handcuff attachment clip can engage a portion of the handcuffs present. Proximate to the handcuff aperture, and closer in direction to the top, open end, of the enclosure assembly can be the constraining strap aperture, through which the free end of the constraining strap can pass from the front of the enclosure assembly to the back of the enclosure assembly. There can be matching and co-located apertures in the front material and back material, as can be true for all apertures herein wherein a strap can pass from the front of the enclosure assembly to the back of the enclosure assembly or vice versa. This can be in contrast to the handcuff aperture which can be only an opening in one material of an enclosure assembly and passage can only be from the exterior of the enclosure assembly to the interior of the enclosure assembly.

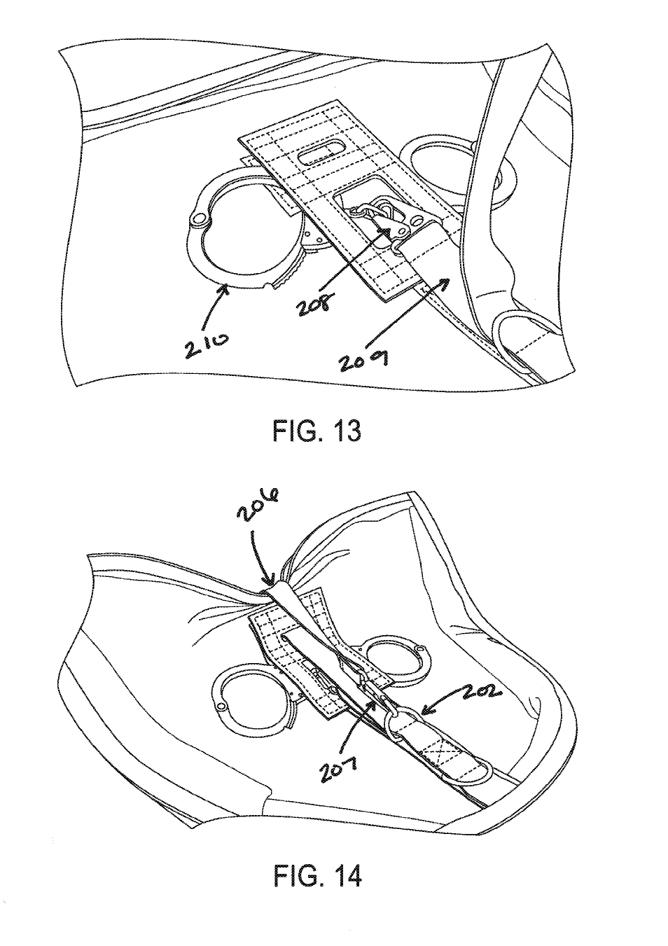

A close up of the apertures of the dual hand restraint enclosure assembly is shown in FIG. 13, and the enclosure assembly 200 can be enclosing a pair of handcuffs 210. The handcuff attachment clip 208 can be engaged with the chain section of the pair of handcuffs. The handcuffs can be within the interior of the enclosure assembly and the handcuff aperture 203 allows the handcuff attachment clip affixed to the free end of the handcuff strap to traverse from the exterior of the enclosure assembly to the interior of the enclosure assembly to engage the handcuffs.

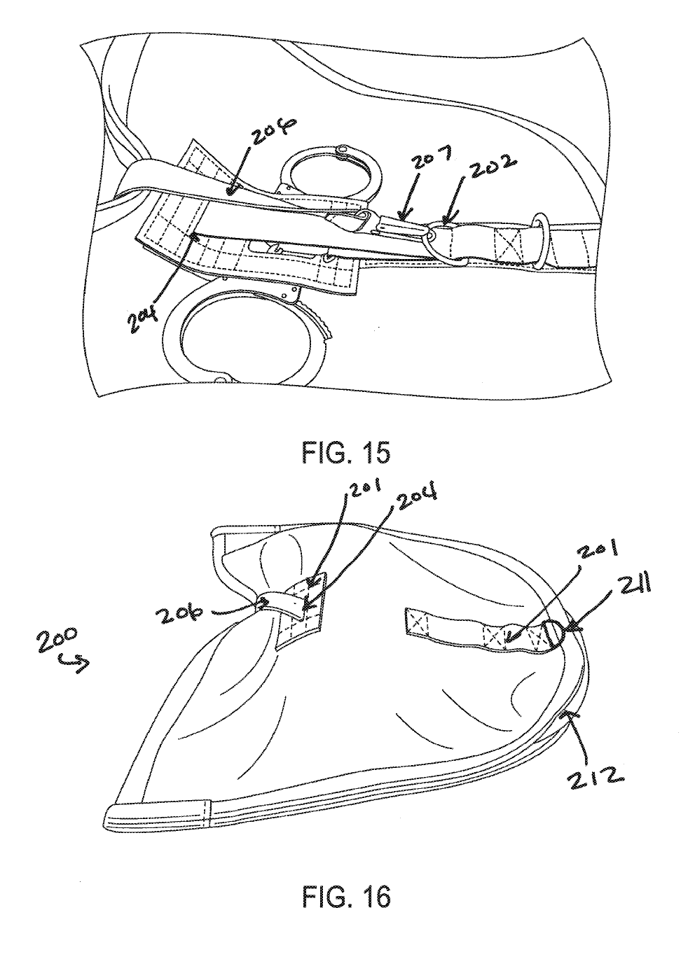

In a method of using this enclosure assembly, handcuffs can be placed on the wrists of the person being restrained. Both hands can be placed into the dual hand restraint enclosure assembly. The free end of the handcuff strap comprising a handcuff attachment clip can be moved from the exterior of the enclosure assembly to the interior of the enclosure assembly and engages the chain (or rod) of the handcuffs. This holds the handcuffs, and the hands of the person wearing the handcuffs, in substantially one location within the enclosure assembly. With the handcuff attachment clip engaged, the free end of the constraining strap can be moved from the front of the enclosure assembly through the constraining aperture to the back of the enclosure assembly. As shown in FIG. 14, the constraining strap 206 can be then drawn over the top, open end, of the enclosure assembly towards the front of the enclosure assembly where the attachment clip 207 affixed to the free end of the constraining strap engages with attachment rings 202 affixed to the reinforced material. A plurality of rings can be affixed proximate to each other to provide variability in the about of constriction of the enclosure assembly by the constraining strap. The attachment rings can be affixed proximate to the bottom, closed end, of the enclosure assembly. FIG. 15 shows the constraining strap 206 passing from the front of the enclosure assembly 200, through the constraining aperture 204 to the back of the enclosure assembly, and back to the front of the enclosure assembly, over the open end of the enclosure assembly, and engaging the attachment clip 207 with an attachment ring 202. Through the front transparent or clear material the handcuffs, stabilized within the enclosure assembly by the handcuff attachment clip affixed to the handcuff strap, can be easily seen as would be any hands that were placed within the enclosure assembly. Should more constriction of the enclosure assembly be needed, the constraining strap attachment clip could be engaged with the attachment ring located further away from the open end of the enclosure assembly and more proximate to the closed end of the enclosure assembly. FIG. 16 shows a view of the dual hand restraint enclosure assembly 200 from the back. The mesh surface of the back material can have reinforced material 201 attached to it and defining the constraining aperture 204 where the constraining strap 206 passes from the front of the enclosure assembly through the co-located constraining apertures of the front and back material (to form a constraining aperture) to the back of the enclosure assembly. The strap then crosses the top open end of the enclosure assembly and continues down the front of the enclosure assembly to engage the attachment ring (not shown). Located on the back material shown in FIG. 16 can be reinforced material 201 that can be used for affixing an attachment ring 211 for engaging with a strap. As can be also shown in FIG. 16, there can be a gusset 212 of material provided between the front surface material and back surface material to give a little more depth to the enclosure assembly itself.

A system of the present invention comprises a restraint system comprising a combination of assemblies disclosed herein. For example, a restraint system comprising a restraint enclosure assembly disclosed herein, attached to and used with, a restraint belt or with a belly chain. One or more restraint enclosure assemblies can be used with a belt. A system of the present invention comprises two of the individual enclosure assemblies used with and attached to a waist restraint belt or belly chain. A system of the present invention comprises at least one individual or single enclosure assemblies disclosed herein in combination with a waist restraint belt and/or a restraint vest. A system of the present invention comprises use of two of the individual or single enclosure assemblies disclosed herein in combination with and attached to a waist restraint belt. A system of the present invention comprises use of two of the individual or single enclosure assemblies disclosed herein in combination with and attached to a restraint vest. A system of the present invention comprises use of two of the individual or single enclosure assemblies disclosed herein in combination with and attached to a waist restraint belt attached to a vest. A system of the present invention comprises use of at least one of the individual or single enclosure assemblies disclosed herein in combination with and attached to a waist restraint belt. A system of the present invention comprises use of at least one of the individual or single enclosure assemblies disclosed herein in combination with and attached to a waist restraint belt attached to a restraint vest. A system of the present invention comprises use of at least one of the individual or single enclosure assemblies disclosed herein in combination with and attached to a restraint vest. A system of the present invention comprises use of dual hand restraint enclosure assembly disclosed herein in combination with and attached to a waist restraint belt. A system of the present invention comprises use of dual hand restraint enclosure assembly disclosed herein in combination with and attached to a waist restraint belt that can be attached to a restraint vest. A system of the present invention comprises use of dual hand restraint enclosure assembly disclosed herein in combination with and attached to a restraint vest.

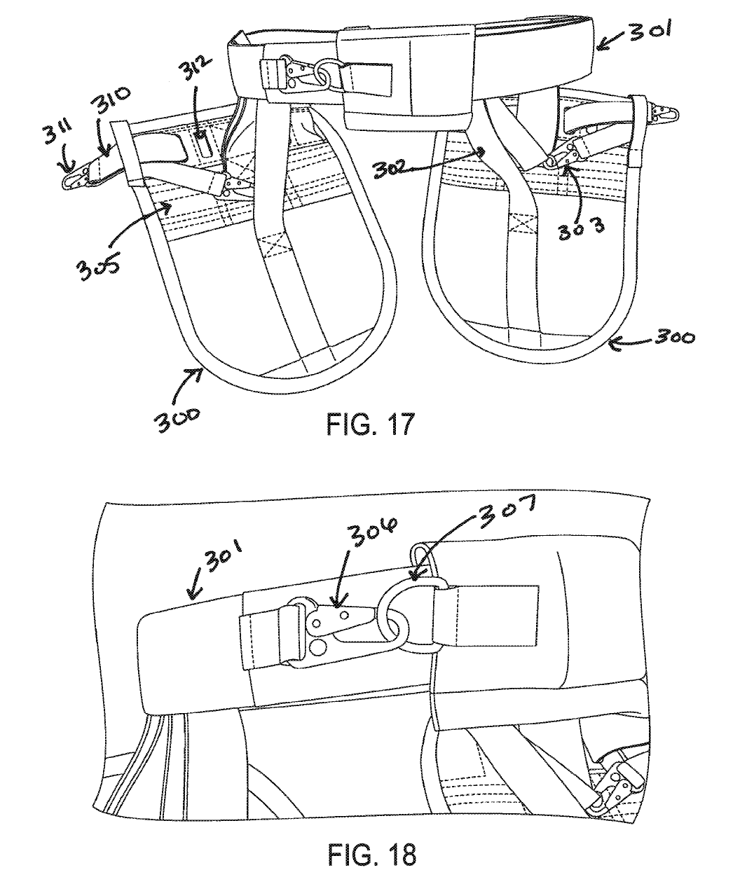

As shown in FIG. 17, a pair of hand restraint enclosure assemblies 300 comprising a handcuff can be attached to a waist restraint belt 301. The hand restraint enclosure assembly 300 comprising a handcuff shown in FIG. 17 comprises a strap 302 wherein the free end of the strap comprises a ring 303 to which a single handcuff 304 can be affixed, and can be referred to as a hand restraint enclosure assembly comprising a handcuff. As shown in FIG. 17, for an exemplary enclosure assembly, the strap 302 can be affixed to the back material of a hand restraint enclosure assembly comprising a handcuff, and in the exemplary embodiment shown, the strap can be affixed to the back material from the bottom of the enclosure assembly to the reinforced material proximate to the cuff region 305 of the back material of the enclosure assembly. The exemplary hand restraint enclosure assembly 300 comprising a handcuff of FIG. 17 comprises reinforced material forming a band proximate to the cuff region and between the cuff region and the bottom of the enclosure assembly. The cuff region of the hand restraint enclosure assembly comprising a handcuff can be similar to the cuff region described for other enclosure assembly embodiments herein and comprises apertures formed through the front and back material, and through any reinforced material present in the cuff for the weaving of the constraining strap to constrict the open end of the enclosure assembly. The cuff region also comprises attachment sites comprising attachment rings for engaging the attachment clip affixed to the free end of the constraining strap. Attachment sites or attachment rings for attaching to a strap provided by a waist restraint belt or a restraint vest can be located on the front or back material of the back, or to reinforced material affixed to the front or back material of the enclosure assembly. Attaching straps can be provided on the waist restraint belt or can be provided from the enclosure assembly. In either case a clip or other attaching mechanism connects the strap to the belt or to the enclosure assembly, as the case may be. The handcuff strap comprising the handcuff attachment clip can be affixed on its affixed end in the cuff region, for example, to the reinforcing material affixed to the back material. The handcuff strap can be generally relatively short so that it can reach the handcuff aperture in the back material but not have a range much longer than that distance. The handcuff aperture can be surrounded and defined by reinforced material affixed to the back material. The handcuff aperture can be limited to providing an opening from the back of the back to the interior of the enclosure assembly and does not have a matching aperture through the front material.

FIG. 18 shows a closure mechanism for a waist restraint belt 301 where an attachment clip 306 engages an attachment ring 307. A waist restraint belt can be use any closure mechanisms known in the art and the type of closure should not be construed as limiting the invention.

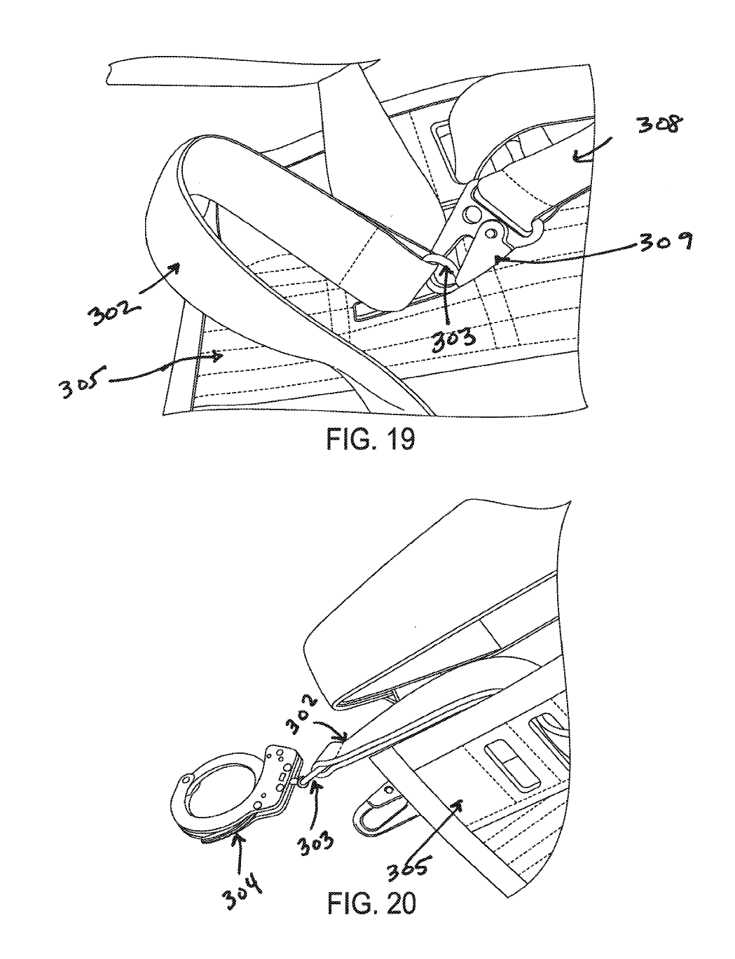

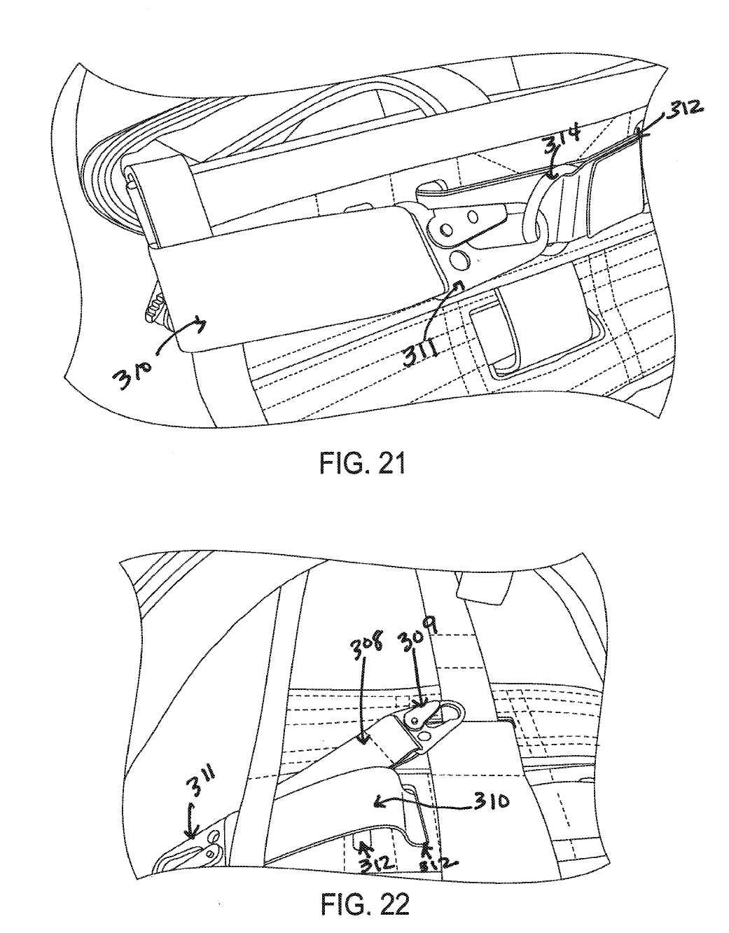

In the hand restraint enclosure assembly comprising a handcuff, a strap can be attached to a single handcuff that can be placed within the enclosure of the enclosure assembly. As shown in FIG. 19, the handcuff strap 308 comprising a handcuff attachment clip 309 engages the ring 303 that can be affixed to the end of the strap comprising a handcuff and to one handcuff 304. The handcuff strap substantially stabilizes the handcuff in one place inside the enclosure assembly. As shown in FIG. 20, the strap comprising a single handcuff 304 can be removed from the interior to the exterior of the enclosure assembly 300, which can be helpful when moving the constrained person's hand from the interior of the enclosure assembly. FIG. 21 shows a constraining strap 310 woven through the constraining apertures 312 and the attachment clip 311 engaging the attachment ring 314. The constraining strap can be woven through the apertures, from the front to back of the enclosure assembly and vice versa, as shown in the figure (and others herein) and constricts the top of the enclosure assembly.

FIG. 22 shows a hand restraint enclosure assembly 300 comprising a handcuff from the mesh material side (the back of the bag) having the constraining strap 310 woven through the constraining apertures 312 and also shows a handcuff strap 308 and handcuff attachment clip 309 not engaged.

Assemblies of the present invention comprise restraint enclosure assembly useful for encasing one or more hands of a person, a primate or other animal to be restrained. Assemblies described herein can be used for restraining one or more hands of a human, a primate or other animals (wherein the appropriate nomenclature can be paw or paws, or another appropriate term). Humans can be the preferred species for the disclosed restraint enclosure assembly and, for simplicity in description, hands and humans can be exemplified.

An assembly of the present invention comprises a hand restraint enclosure assembly. The hand restraint enclosure assembly encases one hand of the restrained person and can comprise elements of enclosure assemblies disclosed herein. For example, a hand restraint enclosure assembly can comprise a cuff region having affixed thereto a constraining strap having a free end comprising an attachment clip, constraining apertures, attachment sites comprising attachment rings for engaging the attachment clip of the constraining strap or for engaging attaching straps or chains from a waist restraint belt, a belly belt, a restraint vest or a structure. A hand restraint enclosure assembly does not generally comprise a handcuff attached to a strap, unless otherwise indicated. A hand restraint enclosure assembly comprises an enclosure assembly as formed as described herein. A hand restraint enclosure assembly can be made from a front material and a back material, which can be the same or different materials. A hand restraint enclosure assembly can have a first material that forms the front of the enclosure assembly and can be referred to herein as the front material. The front or first material can be transparent or clear so that the interior of the enclosure assembly and any hands therein can be seen from the outside. The second or back material can be different, for example can be a mesh material that can be sturdy and can be allow transmission of air through the material. A hand restraint enclosure assembly can comprise a handcuff strap affixed to the back of the enclosure assembly or to a reinforced material affixed to the back of the back, for example proximate to the cuff region. The handcuff strap can be affixed on one end to the back of the enclosure assembly, and comprises a handcuff attachment clip on its free end. The back material of the enclosure assembly can comprise a handcuff aperture that can provide access through the back material, and any reinforcing material present, to the interior of the enclosure assembly. The handcuff strap can have a length that provides the handcuff attachment clip to the handcuff aperture, but not longer, so that when the handcuff can be engaged by the handcuff attachment clip the handcuff can be substantially stabilized in one location within the hand restraint enclosure assembly. Other components or elements that can be common or desired as described for enclosure assemblies disclosed herein can be a part of a hand restraint enclosure assembly. For example, the front material can be transparent or clear.

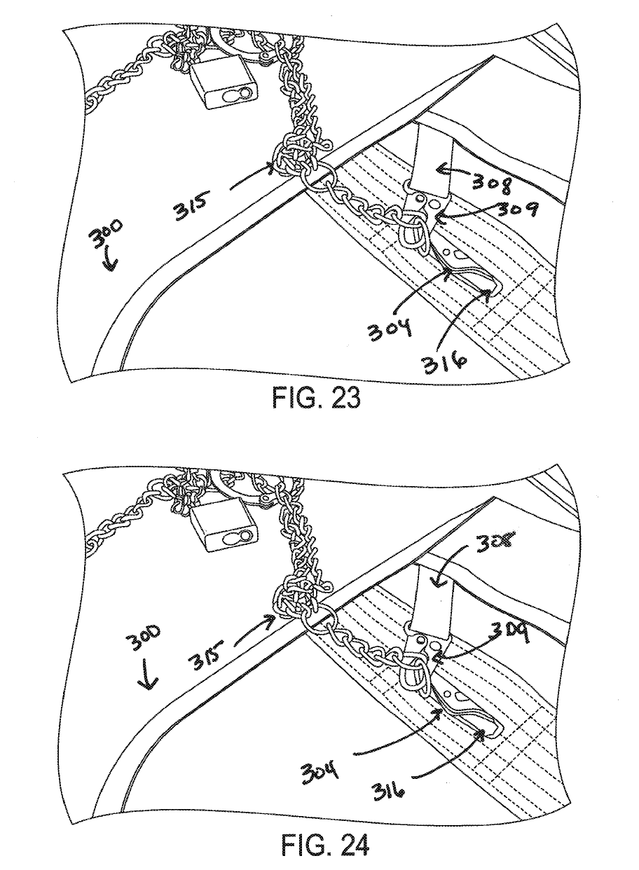

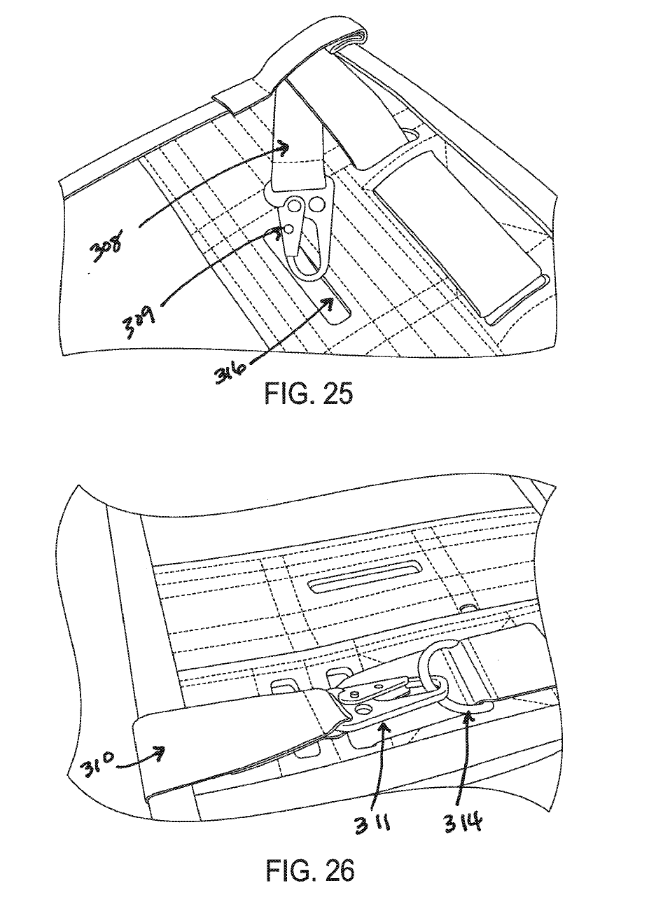

FIG. 23 shows the mesh material of the back side of a hand restraint enclosure assembly 300 wherein the handcuff strap 308 comprises a handcuff attachment clip 309, and the handcuff attachment clip can be engaged with the handcuff 304 of a belly chain 315, shown coiled in the upper right area of FIG. 23. The handcuff attachment clip can be engaged with the chain of the handcuff and the handcuff can be in the interior of the enclosure assembly. FIG. 24 shows a similar engagement by the handcuff attachment clip 309 and one handcuff 304 of a belly chain with a handcuff stabilized within a hand restraint enclosure assembly 300. FIG. 25 shows the handcuff strap 308 and the handcuff attachment clip 309 positioned at the handcuff aperture 316 which provides access into the interior of the enclosure assembly 300. This handcuff aperture only goes through the mesh material and does not go through the front material, such as the clear material of the enclosure assembly.

In use of a hand restraint enclosure assembly, a hand having a handcuff around the wrist can be placed within the enclosure of the enclosure assembly. The chain of the handcuff can be engaged by the handcuff attachment clip and the enclosure assembly can be constricted as described herein using the constraining strap. In an alternative method, illustrated in FIG. 24, a handcuff 304 can be placed within the enclosure assembly 300 and the free end of its chain can be moved from the interior of the enclosure assembly to the exterior of the back of the enclosure assembly through the handcuff aperture 316. The chain of the handcuff can be engaged by the handcuff attachment clip 309 so as to constrain the movement of the handcuff 304 within the enclosure assembly. The free end of the chain of the handcuff can be then attached to a belly chain 315 or waist restraint belt 301. Alternatively, the handcuff can be attached to the other chains and the entire chain system can be fed through the handcuff aperture. In use, a hand can be placed within the enclosure assembly and the handcuff can be applied to the wrist within the enclosure assembly. The enclosure assembly can be then closed using a constraining strap as disclosed herein. A hand restraint enclosure assembly can be then be attached to a belt restraint, to another hand restraint enclosure assembly, to a vest, to a belly chain, or a structure as desired. A hand restraint enclosure assembly can have an attachment strap for attaching the hand restraint enclosure assembly to another assembly or structure, or a hand restraint enclosure assembly can have an attachment site, such as an attachment ring, for engaging with the strap of another assembly or structure, or an attaching element provided by the other assembly or structure.

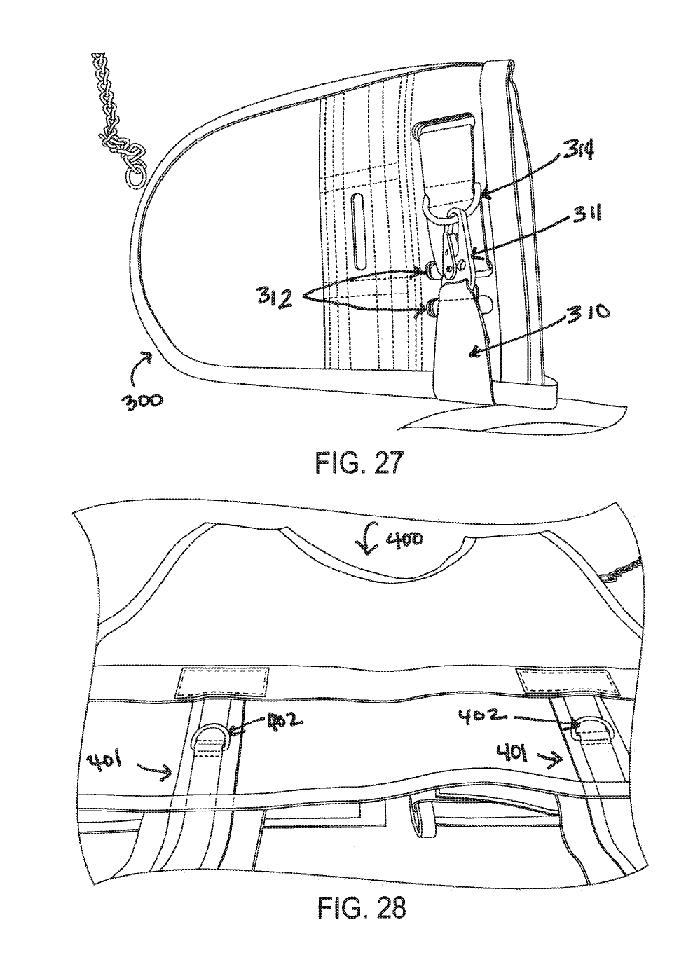

FIG. 26 shows the constraining strap 310 of the cuff region 305 of a hand restraint enclosure assembly 300 wherein the attachment clip 311 can be engaged with an attachment ring 314. FIG. 27 shows the front of a hand restraint enclosure assembly 300, with the constraining strap 310 interwoven through the constraining apertures 312 located at the top of the enclosure assembly.

The present invention comprises a restraint vest. The restraint vest can be open on the sides, which can be reversibly closed so that the side of a restrained person can be easily reached. A vest of the present invention can be a one-piece garment that can be shaped to be worn on the torso of a human or primate, and can be donned by side entry through the open sides or can be pulled over the head and the sides closed. The vest can be worn over clothing or protective armor. A vest of the present invention can comprise affixed straps having a free end comprising an attachment clip. The vest can comprise attachments sites for attaching a waist restraint belt or straps provided by an enclosure assembly disclosed herein.

As a part of a kit of the present invention, a kit can comprise a vest, a waist restraint belt and one or more enclosure assemblies as described herein. A vest can be worn by a restrained person, along with a waist belt and one or more enclosure assemblies disclosed herein. A vest can have attachment means so that a restraint belt can be attach to a portion of the vest and the waist restraint belt can be used to attach to enclosure assemblies disclosed herein. Alternatively, one or more enclosure assemblies disclosed herein can be attached directly to a vest. A kit can comprise a waist restraint belt and one or more enclosure assemblies disclosed herein.

As shown in FIG. 28, a vest 400 can be viewed from the waist area of the vest looking towards the neck area of the vest. Two of a belt loop member 401 comprising attachment ring 402, a belt loop attachment clip 403 and hook and loop closure materials is shown, one on the left and one on the right of the vest. A belt loop 401 member comprises an attachment ring 402 and a belt loop clip 403, and optionally can comprise hook and loop closure 404, e.g., Velcro®.

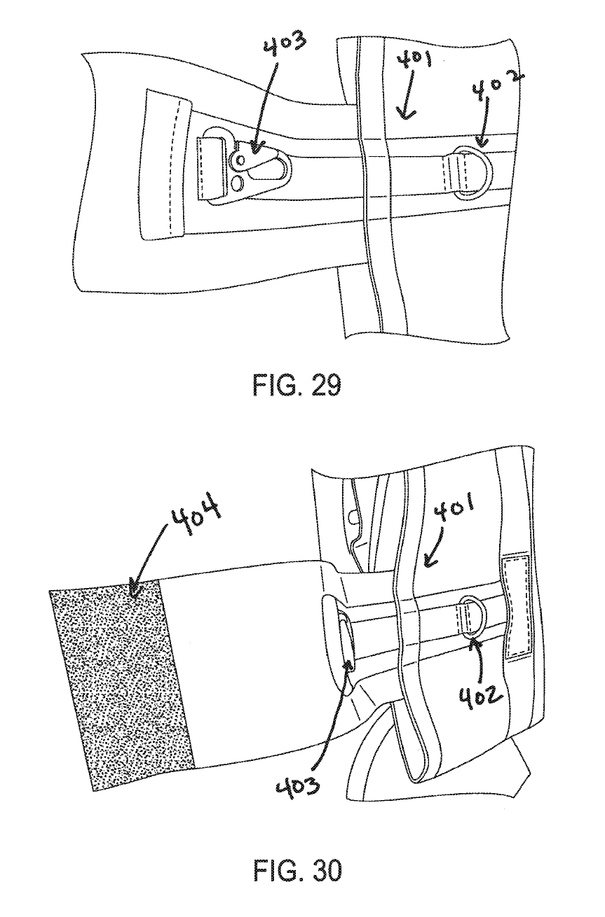

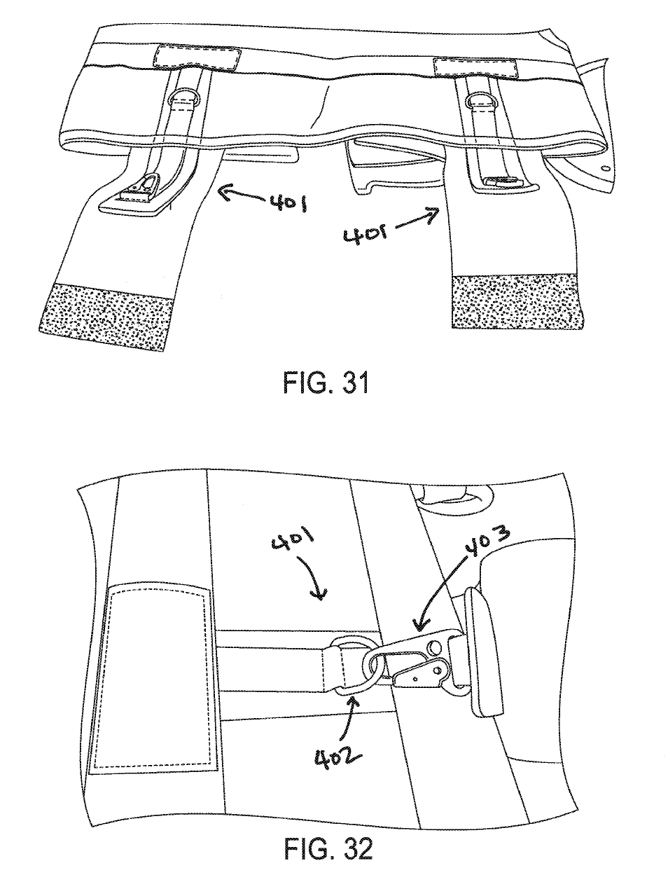

FIG. 29 shows a close up view of the belt loop member 401. The belt loop member comprises attachment ring 402 and a paired belt loop clip 403 for engaging the attachment ring such that when the latch can be moved to engage the attachment ring, a belt loop can be formed in the area described by the material to which the belt loop clip can be affixed. As shown in FIG. 30, additional attachment means such as paired hook and loop 404 material can be placed on the end of the material to which the belt loop clip 403 can be affixed so that when the belt loop can be closed i.e., the belt loop clip can be engaged with the attachment ring, the hook and loop material mate and aid in holding the belt loop in place. FIG. 31 shows the two belt loop members 401 in an open position. Such belt loop members can be found on both the front and the back of the vest and multiple belt loop members can be affixed on a vest. The belt loop members can be located anywhere on the edge of the vest away from the neck hole formed in the one-piece material forming the vest. A one-piece garment vest is described in U.S. Pat. No. 7,181,772. A vest 400 of the present invention comprises one piece of material shaped to cover the torso, so that a hole can be provided at the mid-section and centrally placed in a generally rectangular piece of material. The hole can be made for a head to go through and the material can be to then drape on the shoulders and long enough to reach near a waist area of a human. The sides can be open and can be reversibly closed by closure methods known in the art and disclosed herein, including but not limited to, straps, clips and attachment rings, and paired hook and loop material that engage when pressed together. A vest can be made of any sturdy material that can be resistant to tearing and long lasting. A mesh material that allows for transmission of air would be more comfortable for the wearer, and can be contemplated.

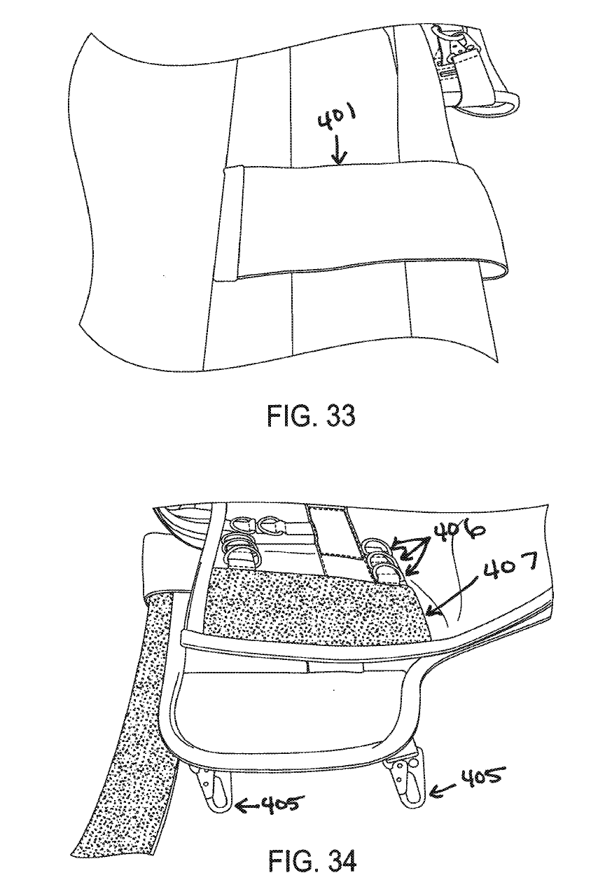

FIG. 32 shows the belt loop clip 403 engaged with the attachment ring 402 of the belt loop member 401. FIG. 33 shows the belt loop 401 closed with the belt loop clip engaged with the attachment ring and the hook and loop material engaged and forming the belt loop on the vest 400.

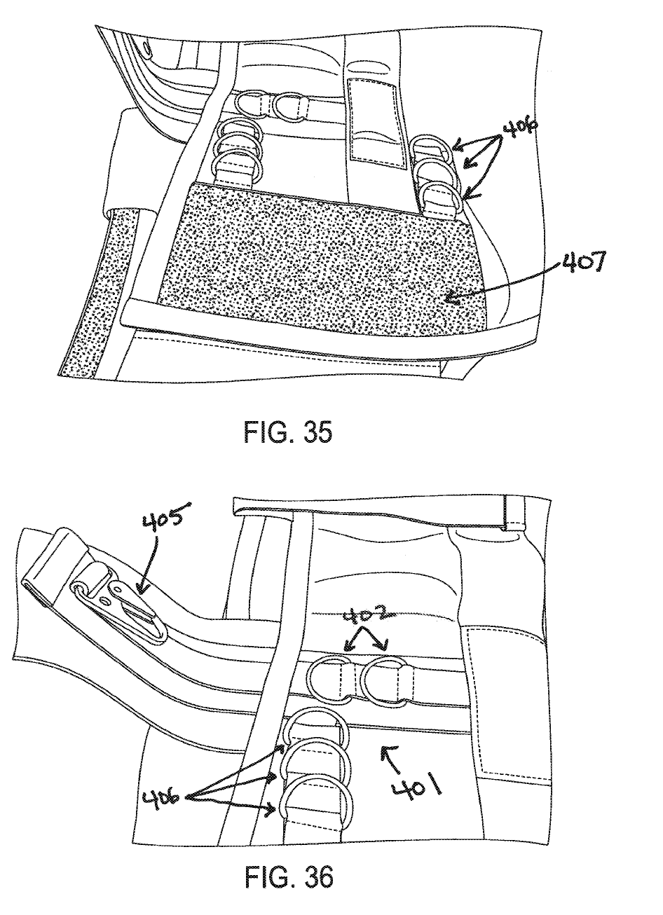

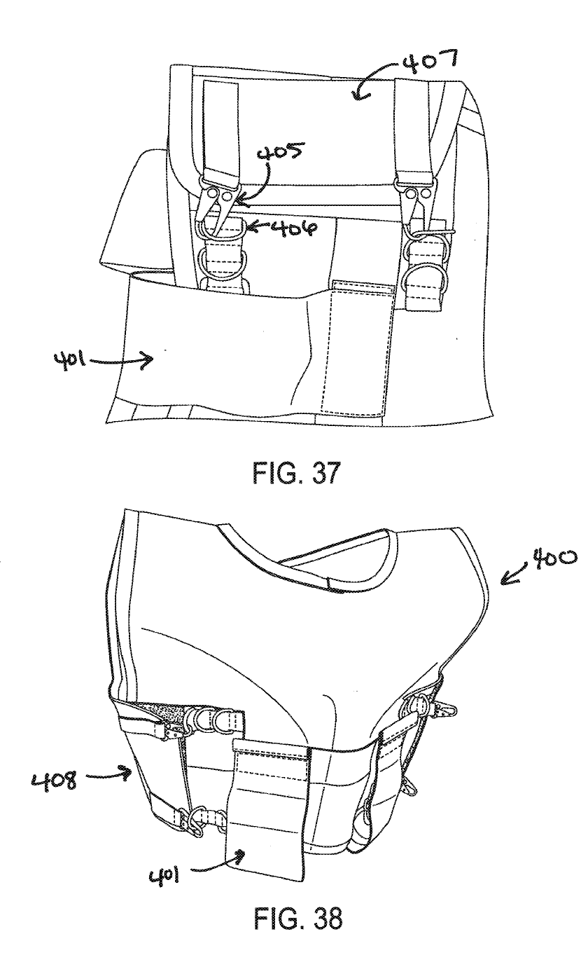

A vest 400 of the present invention can be adjustable so that the vest can be opened from the sides easily. FIG. 34 shows such a side closure and adjustment member comprising attachment clips 405, attachment rings 406 and optionally, hook and loop material 407. The side closure and adjustment member of the vest can have one or more attachment clips, each of which can engage with one of a plurality of attachment rings found on the front or back of the vest, depending on the orientation of the side closure and adjustment member. The plurality of attachment rings provide for the ability to close the vest side more tightly or more loosely. FIG. 35 shows an attachment ring system 406 for adjustment of the vest in addition to a section of hook and loop material 407 for additional closure of the side closure and adjustment member. FIG. 36 shows a close up of one portion of the side closure and adjustment member of the vest, showing three attachment rings 306, along with the belt loop member 401 having two rings 402. FIG. 37 shows the side closure and adjustment member with the attachment clips 405 engaged and the hook and loop material engaged 407. The belt loop member 401 can be also shown as closed and forming the belt loop. FIG. 38 shows the vest 400 closed with closed belt loops 401 and the side closure and adjustment member 408 engaged to form a substantially entire vest that would enclose the torso of a human.

A system of restraint of the present invention comprises a vest to which a waist restraint belt can be held within the belt loop formed by one or more of the belt loop members of the vest, attachment straps from the waist restraint belt having an attachment clip engaged with an attachment ring affixed to at least one enclosure assembly, and an enclosure assembly disclosed herein.

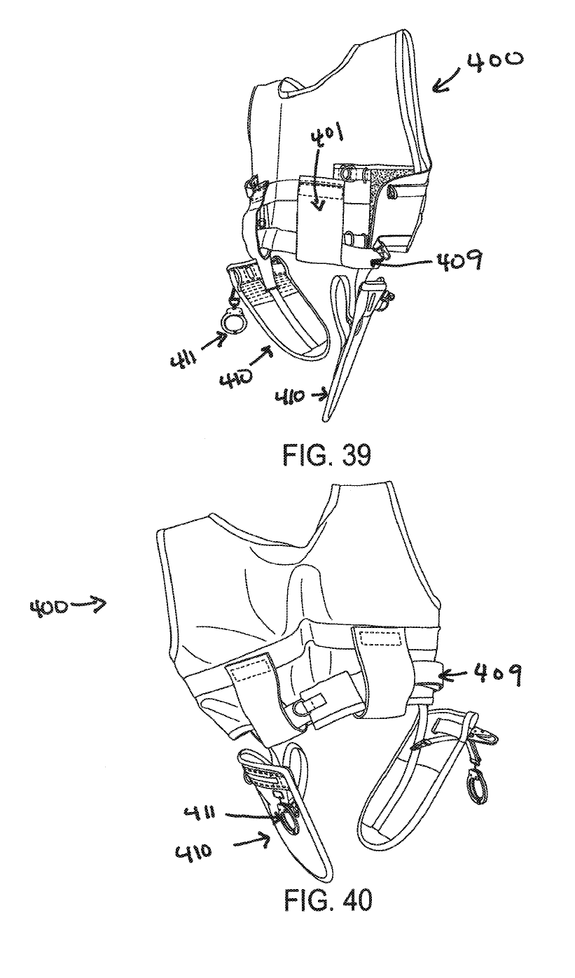

FIG. 39 shows a vest 400 with a waist restraint belt 409 contained by the belt loop elements 401 wherein the waist restraint belt can have two single enclosure assemblies 410 comprising a handcuff attached 411. Shown in FIG. 40 can be a system comprising a vest 400, a waist restraint belt 409 and two hand restraint enclosure assemblies 410, each comprising a handcuff 411.

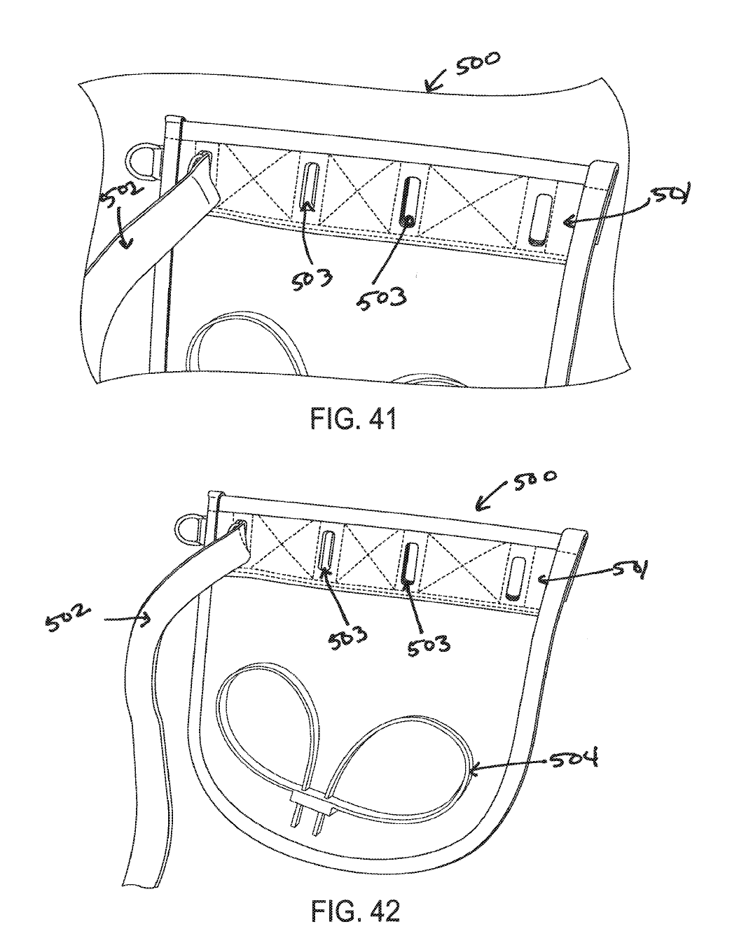

FIG. 41 shows the cuff region 501 of an enclosure assembly for two hands 500, wherein the hands can be restrained by flex cuffs or handcuffs. The enclosure assembly can be made like the enclosure assemblies disclosed herein, having a clear front material so that the enclosed hands can be visible, and a mesh material for the back of the back. Reinforcing material can be used as needed. FIG. 41 shows enclosure assembly 500 wherein the constraining strap 502 provides separation of the wrists and thus hands, by interweaving the constraining strap through the constraining apertures 503 shown. For example, there can be four spaced apart constraining apertures 503 in the cuff region. The constraining strap can be affixed on end to the back side cuff region and the free end, comprising an attachment clip, can be moved through the first aperture, which can be closest to the left hand side of the enclosure assembly as shown in FIG. 41, from the back of the enclosure assembly to the front of the enclosure assembly. From the front of the enclosure assembly, the free end of the constraining strap can be moved through the next aperture to the right of the first aperture from the front of the enclosure assembly to the back of the enclosure assembly. This provides the isolation for an arm or wrist entering the enclosure assembly at that location. The constraining strap can be then moved from the back of the enclosure assembly through the next aperture in line, the one to right of the second aperture, and then the free end of the constraining strap can be moved from the front to the back of the enclosure assembly through the fourth aperture, proximate to the right hand side of the enclosure assembly as shown in FIG. 41. This isolates and stabilized the other arm or wrist, and thus the hands restrained within the enclosure assembly in the flex cuffs.

FIG. 42 shows a set of flex cuffs 504 contained within the enclosure assembly 500 so that the flex cuffs can be placed on hands and once the hands can be placed within the enclosure assembly with the flex cuffs in place, the constraining strap can be woven through the constraining apertures as disclosed above.

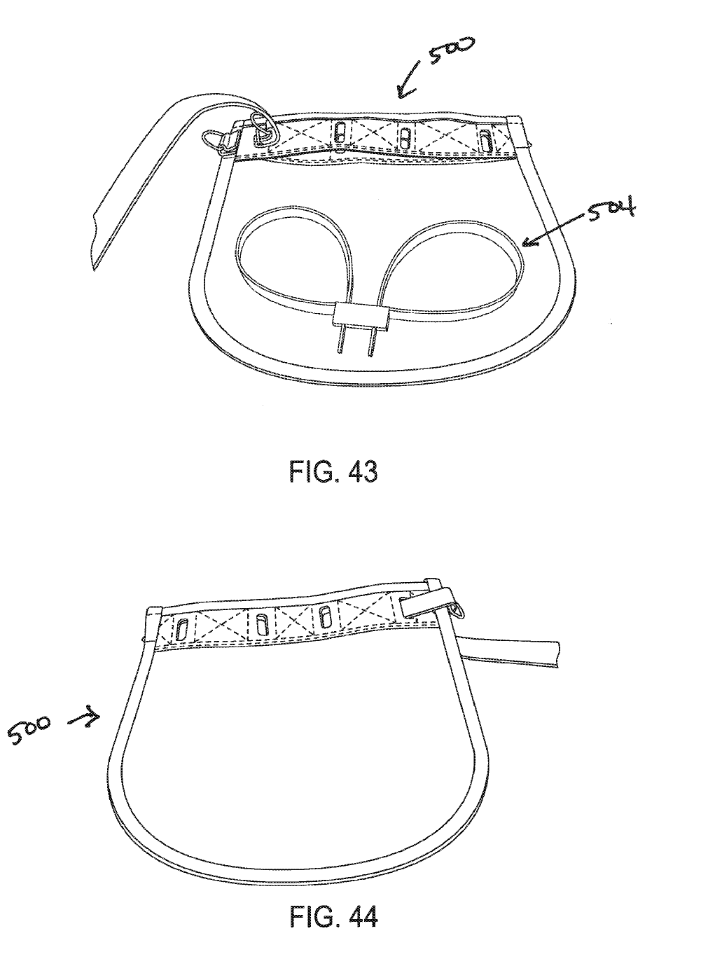

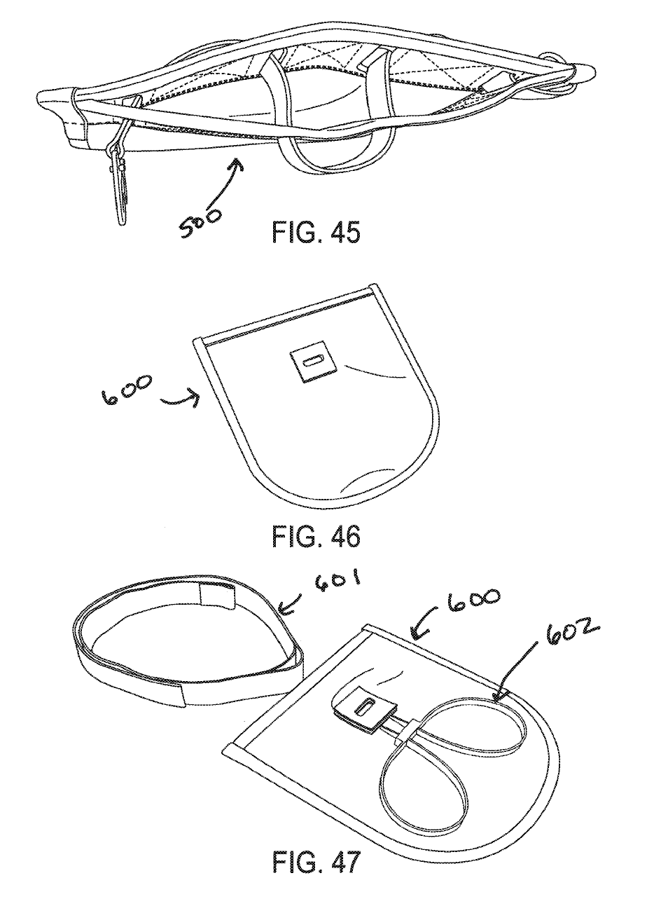

FIG. 43 shows the enclosure assembly 500 from a bottom of the enclosure assembly angle. FIG. 44 shows the back of the enclosure assembly 500 showing the mesh material of which this exemplary enclosure assembly can be made. FIG. 45 shows a view towards the interior of the enclosure assembly 500.

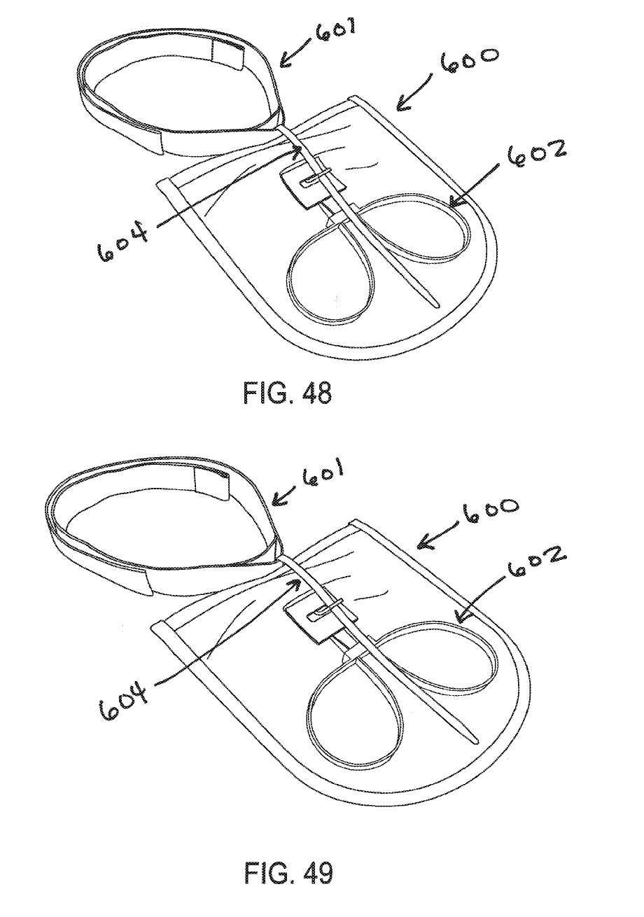

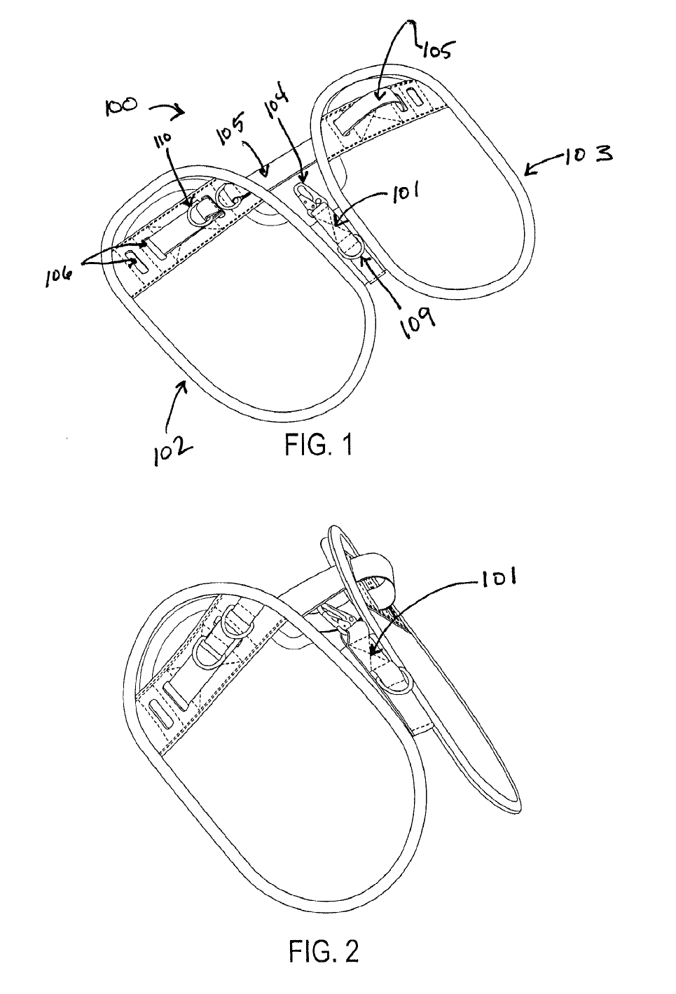

Another embodiment of the present invention shown in FIG. 46 can be an enclosure assembly 600 made as disclosed herein where the enclosure assembly comprises two materials, a front material that can be transparent or clear, and sturdy, a back material can be the same or different and is shown herein as being made of a mesh. This enclosure assembly embodiment comprises one aperture that provides an opening through both the front material and the back material by having co-located apertures that oppose each other when the enclosure assembly can be formed. The aperture can be formed in a central location and more proximate to the open top of the enclosure assembly than to the bottom, closed end of the enclosure assembly. Hands in hands in handcuffs or flex cuffs can be placed within the enclosure assembly, and a zip tie or a strap with an attachment clip and attachment ring, or other closure mechanism, can be moved through the aperture and the zip tie or strap can be engaged to form a closed loop that can be circles the top of the enclosure assembly through the aperture. As shown in FIG. 47 the enclosure assembly 600 can be attached to a belt 601. Also shown in 47 can be the enclosure assembly containing a pair of flex cuffs 602 wherein in use the flex cuffs would be around the wrists of a person and those hands would be placed within the enclosure assembly. A zip tie or strap 604 can be used to constrain the top of the enclosure assembly so that the hands can be maintained in the flex cuffs within the enclosure assembly. The zip tie can be used to connect to the belt or there can be a separate belt connection. FIGS. 48 and 49 show a zip tie 604 engaged to constrict the enclosure assembly to prevent movement of the handcuffed hands from the interior of the enclosure assembly.

Closures provided herein by constraining straps can be alternatively closed with zip ties or reinforced by placing zip ties through the same apertures being used by the constraining strap.

In another aspect, the disclosure provides for a hand restraint enclosure assembly, comprising: an enclosure having a closed end and an open end opposite the closed end formed by joining a front panel and a back panel and operable to receive a hand with an applied cuff, wherein the front panel and back panel cooperate to define a cuff region proximate the open end, the front panel comprising a front portion of the cuff region, the back panel comprising a back portion of the cuff region, further comprising: a handcuff aperture defined in the back portion of the cuff region configured to provide access to the applied cuff when positioned in an interior of the enclosure; a handcuff clip operatively associated with the cuff region, wherein the handcuff clip is operable to secure the enclosure to the applied cuff; a constraining strap operatively associated with the cuff region configured to minimize relative movement between the hand and the enclosure. In a further aspect, the front panel of the enclosure is formed from a transparent material. In a further aspect, the back panel of the enclosure is formed from a mesh material. In a further aspect, the front panel and the back panel are joined together via a gusset. In a further aspect, the enclosure further comprises a plurality of constraining apertures defined between a top portion of the cuff region and the horizontal position of the cuff aperture, wherein the constraining strap comprises at least one end joined to the back portion of the cuff region, wherein the constraining strap is operable to weave through the plurality of constraining apertures to further secure the hand restraint enclosure assembly to the cuffed hand. In a further aspect, the handcuff clip is attached to the enclosure via a handcuff strap joined to at least the periphery of the cuff region. In a further aspect, the applied cuff is further connected to a chain restraint belt. In a further aspect, the enclosure is further connected to a belt configured to pass around the waist of a detainee. In another aspect, the disclosure provides for a hand restraint enclosure system comprising: at least one hand restraint enclosure assembly as described above, and a waist restraint belt; wherein the applied cuff is connected to the chain restraint belt. In a further aspect, the at least one hand restraint enclosure assembly further comprises a right hand restraint enclosure assembly and a left hand restraint enclosure assembly. In a further aspect, the waist restraint belt further comprises a chain restraint belt. In a further aspect, the waist restraint belt further comprises at least one attachment strap. In a further aspect, the waist restraint belt further comprises an attachment ring and the at least one attachment strap further comprises a free end having an attachment clip configured to be secured to the attachment ring. In a further aspect, the at least one hand restraint assembly is removably attached to the waist restraint belt. In a further aspect, the at least one hand restraint assembly further comprises a handcuff. In a further aspect, the at least one hand restraint assembly is irremovably attached to the waist restraint belt.

In another aspect, the disclosure provides for a dual hand restraint enclosure assembly, comprising an enclosure having a closed end and an open end opposite the closed end formed by joining a front panel and a back panel and operable to receive a pair of hands with applied handcuffs, wherein the front panel and back panel cooperate to define a cuff region extending along an axis passing through the center of the closed end and the center of the open end, the front panel comprising a front portion of the cuff region, the back panel comprising a back portion of the cuff region, further comprising a handcuff aperture defined in the front portion of the cuff region configured to provide access to a center portion of the applied handcuffs when positioned in an interior of the enclosure; a handcuff clip operatively associated with the cuff region, wherein the handcuff clip is operable to secure the enclosure to the applied handcuffs; a constraining strap operatively associated with the cuff region configured to minimize relative movement between the hand and the enclosure. In a further aspect, the enclosure further comprises a plurality of constraining apertures defined between a top portion of the cuff region and the horizontal position of the cuff aperture, wherein the constraining strap comprises at least one end joined to the front portion of the cuff region, wherein the constraining strap is operable to weave through the plurality of constraining apertures to further secure the hand restraint enclosure assembly to the cuffed hand. In a further aspect, the front panel of the enclosure is formed from a transparent material. In a further aspect, the back panel of the enclosure is formed from a mesh material. In a further aspect, the front panel and the back panel are joined together via a gusset.

The present invention can thus be embodied in other specific forms without departing from its spirit or essential characteristics. The described aspects are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A hand restraint enclosure assembly, comprising:
an enclosure having a closed end and an open end opposite the closed end formed by joining a front panel and a back panel and operable to receive a hand with an applied cuff, wherein the front panel and back panel cooperate to define a cuff region proximate the open end, the front panel comprising a front portion of the cuff region, the back panel comprising a back portion of the cuff region, further comprising:
a handcuff aperture defined in the back portion of the cuff region configured to provide access to the applied cuff when positioned in an interior of the enclosure;
a handcuff clip operatively associated with the cuff region, wherein the handcuff clip is operable to secure the enclosure to the applied cuff;
a constraining strap operatively associated with the cuff region configured to minimize relative movement between the hand and the enclosure.

2. The hand restraint enclosure assembly of claim 1, wherein the front panel of the enclosure is formed from a transparent material.

3. The hand restraint enclosure assembly of claim 1, wherein the back panel of the enclosure is formed from a mesh material.

4. The hand restraint enclosure assembly of claim 1, wherein the front panel and the back panel are joined together via a gusset.

5. The hand restraint enclosure assembly of claim 1, wherein the enclosure further comprises a plurality of constraining apertures defined between a top portion of the cuff region and the horizontal position of the cuff aperture, wherein the constraining strap comprises at least one end joined to the back portion of the cuff region, wherein the constraining strap is operable to weave through the plurality of constraining apertures to further secure the hand restraint enclosure assembly to the cuffed hand.

6. The hand restraint enclosure assembly of claim 1, wherein the handcuff clip is attached to the enclosure via a handcuff strap joined to at least the periphery of the cuff region.

7. The hand restraint enclosure assembly of claim 1, wherein the applied cuff is further connected to a chain restraint belt.

8. The hand restraint enclosure assembly of claim 1, wherein the enclosure is further connected to a belt configured to pass around the waist of a detainee.

9. A hand restraint enclosure system, comprising:
at least one hand restraint enclosure assembly as defined in claim 1, and
a waist restraint belt;
wherein the applied cuff is connected to the chain restraint belt.

10. The hand restraint enclosure system of claim 9, wherein the at least one hand restraint enclosure assembly further comprises a right hand restraint enclosure assembly and a left hand restraint enclosure assembly.

11. The hand restraint enclosure system of claim 9, wherein the waist restraint belt further comprises a chain restraint belt.

12. The hand restraint enclosure system of claim 9, wherein the waist restraint belt further comprises at least one attachment strap.

13. The hand restraint enclosure system of claim 12, wherein the waist restraint belt further comprises an attachment ring and the at least one attachment strap further comprises a free end having an attachment clip configured to be secured to the attachment ring.

14. The hand restraint enclosure system of claim 9, wherein the at least one hand restraint assembly is removably attached to the waist restraint belt.

15. The hand restraint enclosure system of claim 9, wherein the at least one hand restraint assembly further comprises a handcuff.

16. The hand restraint enclosure system of claim 15, wherein the at least one hand restraint assembly is irremovably attached to the waist restraint belt.

17. A dual hand restraint enclosure assembly, comprising:
an enclosure having a closed end and an open end opposite the closed end formed by joining a front panel and a back panel and operable to receive a pair of hands with applied handcuffs, wherein the front panel and back panel cooperate to define a cuff region extending along an axis passing through the center of the closed end and the center of the open end, the front panel comprising a front portion of the cuff region, the back panel comprising a back portion of the cuff region, further comprising:
a handcuff aperture defined in the front portion of the cuff region configured to provide access to a center portion of the applied handcuffs when positioned in an interior of the enclosure;
a handcuff clip operatively associated with the cuff region, wherein the handcuff clip is operable to secure the enclosure to the applied handcuffs;
a constraining strap operatively associated with the cuff region configured to minimize relative movement between the hand and the enclosure.

18. The hand restraint enclosure assembly of claim 1, wherein the enclosure further comprises a plurality of constraining apertures defined between a top portion of the cuff region and the horizontal position of the cuff aperture, wherein the constraining strap comprises at least one end joined to the front portion of the cuff region, wherein the constraining strap is operable to weave through the plurality of constraining apertures to further secure the hand restraint enclosure assembly to the cuffed hand.

19. The hand restraint enclosure assembly of claim 17, wherein the front panel of the enclosure is formed from a transparent material.

20. The hand restraint enclosure assembly of claim 17, wherein the back panel of the enclosure is formed from a mesh material.

21. (canceled)
